(19) United States
(12) Patent Application Publication
(10) Pub. No.: US 2026/0324616 A1
(43) Pub. Date: Oct. 22, 2026

(54) PRE-EXIT ORIFICE PRESSURE REDUCTION ELEMENT WITH NARROW FAN ANGLE NOZZLE ON A SELECTIVE MATERIAL APPLICATION SYSTEM TO SLOW EXIT VELOCITY

(71) Applicant: Deere & Company, Moline, IL (US)

(72) Inventor: Samuel E. MARX, Colona, IL (US)

(21) Appl. No.: 19/445,001

(22) Filed: Jan. 9, 2026

Related U.S. Application Data
(60) Provisional application No. 63/792,690, filed on Apr. 22, 2025.

(51) Int. Cl. A01M 7/00

(52) U.S. Cl. CPC A01M 7/0089; A01M 7/0014

(57) ABSTRACT

A mobile agricultural material application machine includes a material tank configured to hold a material, a pump that pumps material from the material tank, and a controllable valve having a valve inlet and a valve outlet and configured to receive material pumped from the material tank and allow material to pass through the valve outlet during a cycle. The material application machine further includes a conduit including an inlet that receives material from the controllable valve, an outlet defining an exit from the conduit through which material can pass to be applied to the agricultural surface. The conduit further includes a pressure reduction element downstream of the inlet and upstream of the outlet and having a selected volume configured to reduce the pressure and exit velocity of the material.

### CROSS-REFERENCE TO RELATED APPLICATION

The present application is based on and claims the benefit of U.S. Provisional Patent Application Serial No. 63/792,690, filed April 22, 2025, the content of which is hereby incorporated by reference in its entirety.

### FIELD OF THE DESCRIPTION

The present description relates to agricultural material application machines. More specifically, the present description relates to reducing exit velocity of material applied by an agricultural material application machine.

### BACKGROUND

There is a wide variety of different types of agricultural machines that apply material to an agricultural field. These machines can be referred to as agricultural material application machines. Some such agricultural material application machines include sprayers, tillage machines with side dressing bars, air seeders, chemical application machines, and planters that have row units.

As one example, a row unit is often mounted to a planter with a plurality of other row units. The planter is often towed by a tractor over soil where seed is planted in the soil, using the row units. The row units on the planter follow the ground profile by using a combination of a down force assembly that imparts a down force to the row unit to push disk openers into the ground and gauge wheels to set depth of penetration of the disk openers.

Row units can also be used to apply material (e.g., pesticides, herbicides, or fertilizer) to the field (e.g., to the soil, to a seed, etc.) over which they are traveling. In some scenarios, each row unit has a valve that is coupled between a source of material to be applied, and an exit orifice. As the valve is actuated, the material passes through the valve, from the source to the exit orifice, and is applied to the field.

Many current systems apply the material in a substantially continuous way. For instance, where the application machine is applying a liquid fertilizer, it actuates the valve to apply a substantially continuous strip of the liquid fertilizer. The same is true of materials that provide other liquid substances, or granular substances, as examples.

The discussion above is merely provided for general background information and is not intended to be used as an aid in determining the scope of the claimed subject matter.

### SUMMARY

A mobile agricultural material application machine includes a material tank configured to hold a material, a pump that pumps material from the material tank, and a controllable valve having a valve inlet and a valve outlet and configured to receive material pumped from the material tank and allow material to pass through the valve outlet during a cycle. The material application machine further includes a conduit including an inlet that receives material from the controllable valve, an outlet defining an exit from the conduit through which material can pass to be applied to the agricultural surface. The conduit further includes a pressure reduction element downstream of the inlet and upstream of the outlet and having a selected volume configured to reduce the pressure and exit velocity of the material.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a partial top view, partial block diagram of one example of a material application machine.

FIG. 2 is a side view showing one example of a row unit of the material application machine illustrated in FIG. 1.

FIG. 3 is a view of an application unit.

FIG. 4 is a side view showing another example of a row unit of the material application machine illustrated in FIG. 1.

FIG. 5 is a perspective view of a portion of a seed metering system.

FIG. 6 shows an example of a seed delivery system that can be used with a seed metering system.

FIG. 7 shows another example of a seed delivery system that can be used with a seed metering system.

FIG. 8 is a partial pictorial, partial block diagram of one example of a material application machine.

FIG. 9 is a partial pictorial, partial block diagram of one example of a material application machine.

FIGS. 10A-10E are pictorial illustrations showing example material application assemblies including example pressure reduction elements.

FIGS. 11A-11C are pictorial illustrations showing example material application assemblies including example pressure reduction elements.

FIGS. 12A-12B (collectively referred to herein as FIG. 12) are pictorial illustrations showing an example pressure reduction element.

FIG. 13 is a sectional view showing an example pressure reduction element and example nozzle.

FIGS. 14A-14B are top views of furrows and showing examples of discrete material application.

FIGS. 15A-15B are top views of a field and showing examples of discrete material application.

FIG. 16 is a sectional view showing an example pressure reduction element and example nozzle.

FIG. 17 is an exploded view showing an example multi-nozzle assembly.

FIG. 18 is a pictorial view showing an example multi-nozzle assembly.

FIG. 19 is a pictorial view showing an example multi-nozzle assembly.

FIG. 20 is a sectional view showing an example multi-nozzle assembly.

FIG. 21 is a block diagram showing one example of a material application system.

### DETAILED DESCRIPTION

As discussed above, many current systems apply material to a field in a relatively continuous way. This can result in wasted material. For instance, some material that is applied at certain locations between seeds or plants in a field may be unnecessary. This can result in lower productivity and lower efficiency. This problem can be exacerbated in instances where the material is applied at a relatively high rate, such as in the case of high rate fertilizer application.

Some current systems, to address the above-described drawbacks of continuous application, utilize selective material placement. That is, some current systems controllably apply material to discrete target locations, such as to seed or plant locations, or to locations between seeds and plants, rather than as a continuous stream. Such current systems utilize a controllable valve and nozzle and a final, outlet orifice (e.g., a hose or tube extending from the valve or a nozzle downstream of the valve). Material is pressurized and pumped to the valve and the valve is controllably actuated to selectively allow material to the final orifice. Pressure can be adjusted to achieve desired flow rate. As pressure increases, the velocity of material exiting the final orifice increases. The increased velocity alters the atomization profile of the material or can cause reflection of small droplets from the target surface, or both. This can result in less than a desired amount of material being applied to the desired area and can cause material to be applied to adjacent machine components. The application of material to adjacent machine components can cause material build up on the components, may clog or plug the components, and can cause other deleterious effects. Additionally, the increased velocity can cause the material, upon impact with, for example, a seed, cause the seed to move from the desired planting location or orientation, or both, which may result in reduced yield.

The present description thus proceeds with respect to a system that reduces the exit velocity of material exiting a material delivery system and still allows for discrete and selective application of material by controllably actuating a valve and adjusting operation of a pump to adjust pressure of the material. The system includes a pressure reduction element, downstream of the controllable valve and upstream of the final orifice, that reduces the pressure of the material and thereby reduces the exit velocity of the material exiting the final orifice. Reducing the exit velocity can improve the atomization profile of the material and can reduce or prevent the aforementioned deleterious effects of an increased exit velocity.

Also, the present description proceeds with respect to examples of the system being deployed, at least partially, on a material application machine comprising or including row crop planter. It will be understood that in other examples the system can be deployed on a sprayer, an air seeder, a tillage machine with a side-dress bar, or other material application machines.

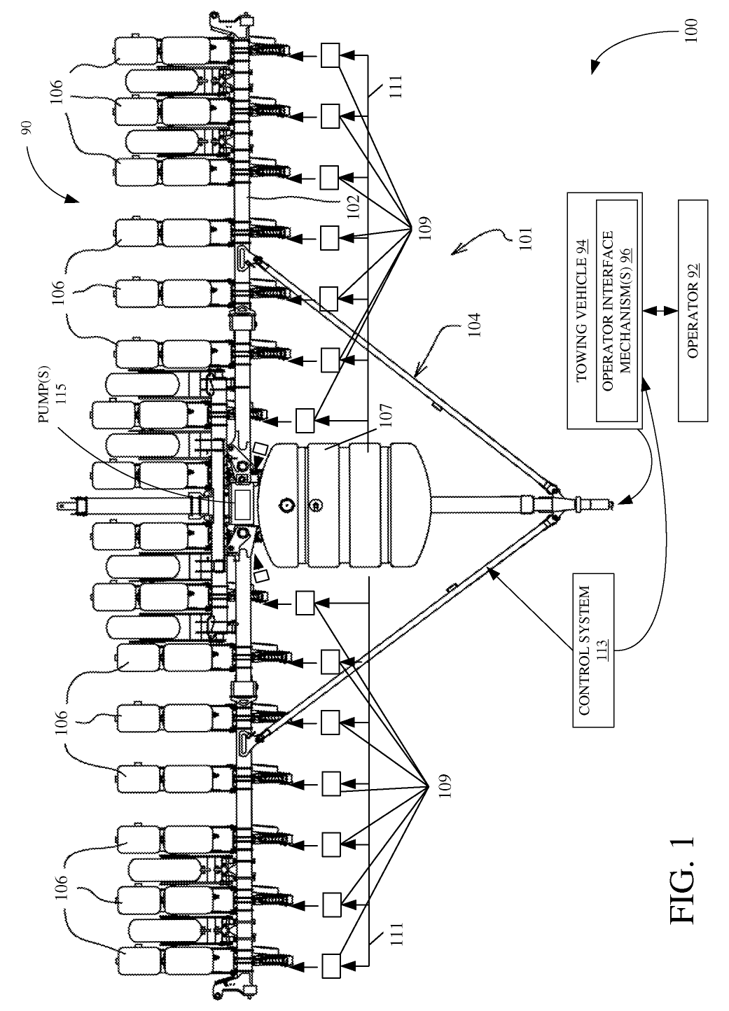

FIG. 1 is a partial pictorial, partial schematic top view of one example mobile agricultural material application machine 100-1 (also referred to herein as material application machine 100-1) that includes a towed agricultural material application implement 101 (also referred to herein as material application implement 101) and a towing vehicle 94, such as a tractor. The towing vehicle 94 includes operator interface mechanisms 96. An operator can interact with operator interface mechanisms 96 to manipulate and control vehicle 94 and some or all portions of material application implement 101. In some examples, as will be discussed below, the material application machine 100-1 can also include a control system located on the material application implement 101 or the towing vehicle 94, or distributed across both, that can automatically control functionality of the material application machine 100. It will be understood that in some examples, a material application machine need not be a towing vehicle and a towed implement, instead, the material application machine can be self-propelled, that is, the apparatus that carries the material application functionality can also include propulsion means.

Material application implement 101, in the example shown in FIG. 1, is a row crop planting implement that illustratively includes a toolbar 102 that is part of a frame 104. FIG. 1 also shows that a plurality of planting row units 106 are mounted to the toolbar 102. FIG. 1 shows that material (e.g., fluid agricultural product, such as fertilizer, pesticide, herbicide, water, etc.) can be stored in one or more tanks 107 and pumped through a supply line 111 so the material can be dispensed in or near the rows being planted. In one example, a set of devices (e.g., actuators) 109 is provided to perform this operation.

In the illustrated example, actuators 109 are valves and one or more pumps 115 pump the material from one or more tanks 107 to valves 109 through supply line 111. The valves 109 can be controllably actuated, e.g., on a per-seed basis, as described below. The control signal for each valve 109, in one example, can be a pulse width modulated control signal. The flow through the corresponding valve 109 can be based on the duty cycle of the control signal (which controls the amount of time the valve is open and closed). The flow through the valve can be based on multiple duty cycles of multiple valves or based on other criteria. The control signal can be a different type of control signal as well, instead of a pulse width modulated control signal. Further, the material can be applied in varying rates on a per-seed or per-plant basis. For example, fertilizer may be applied at one rate when it is being applied at a location spaced from a seed location and at a second, higher, rate when it is being applied closer to the seed location. These are examples only. Additionally, as previously discussed, the operating of the one or more pumps 115 can be controllably adjusted, such as by adjusting the operating speed of the one or more pumps 115, to adjust the operating pressure of the material. As will be understood, the operating pressure can be adjusted to achieve a desired flow rate of the material.

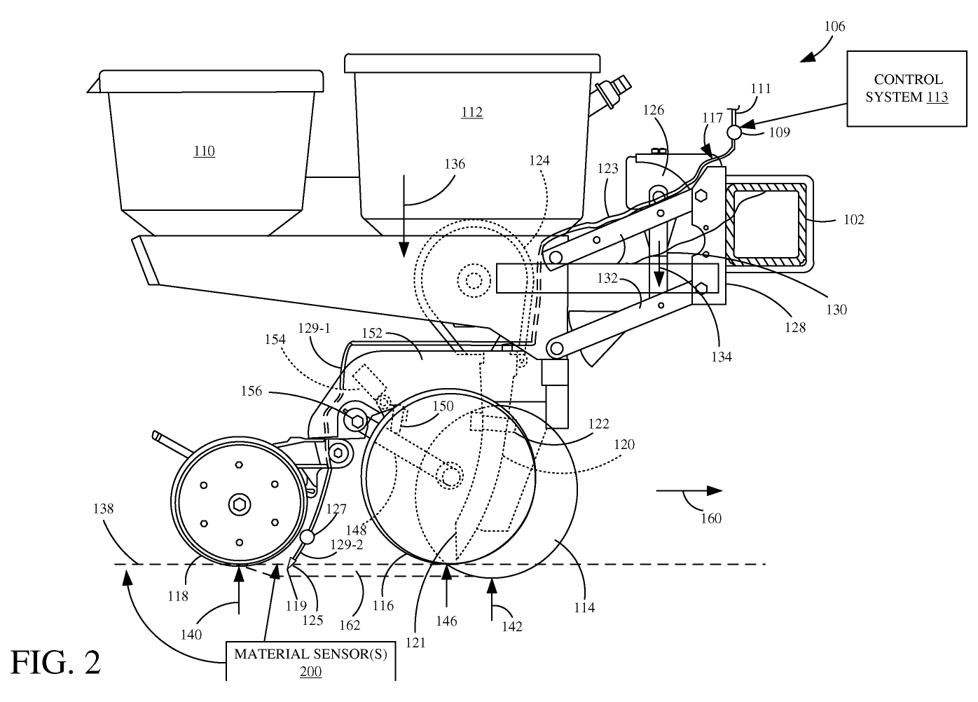

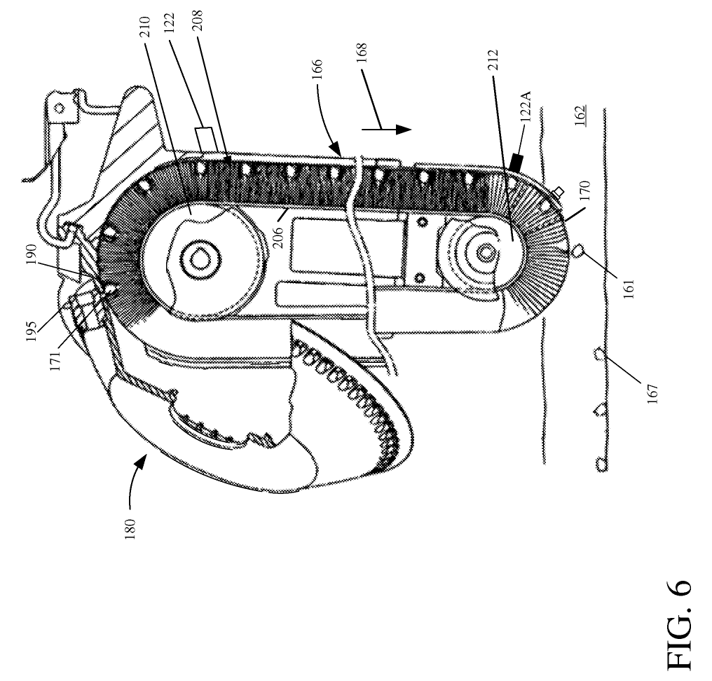

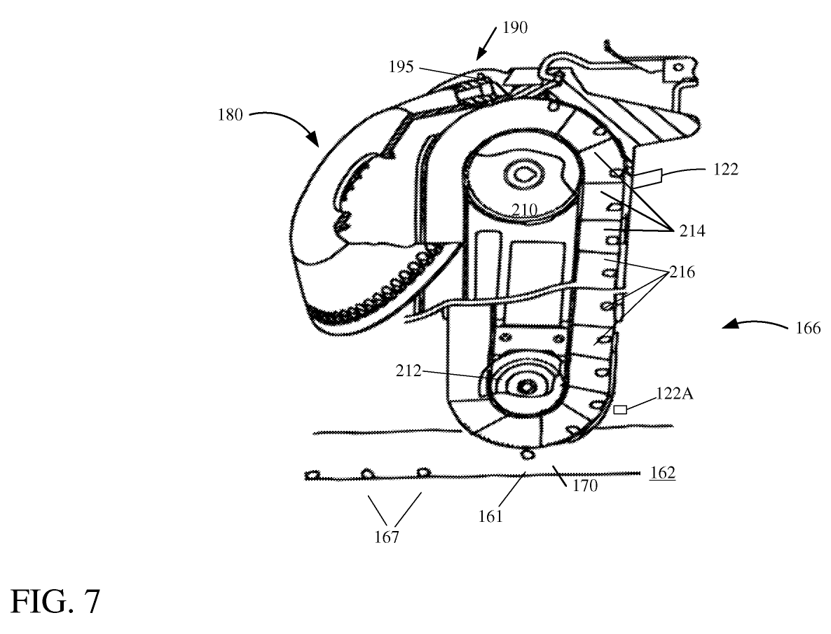

FIG. 2 is a side view of one example of a row unit 106, with valve 109 and system 113 shown as well. Row unit 106 illustratively includes a chemical tank 110 and a seed storage tank 112. It also illustratively includes one or more disc openers 114, a set of gauge wheels 116, and a set of closing wheels 118. Seeds from tank 112 are fed into a seed meter 124, e.g., by gravity or from a centralized commodity distribution system (e.g., exploiting pneumatic commodity distribution to each row unit). The seed meter 124 rotates in the direction indicated by arrow 188 and controls the rate at which seeds are dropped into a seed tube 120 or other seed delivery system, such as a brush belt or flighted belt (shown in FIGS. 6-7, respectively), from seed storage tank 112. The seeds can be sensed by a seed sensor 122.

In the example shown in FIG. 2, liquid material is passed, e.g., pumped or otherwise forced, through supply line 111 to an inlet end of valve 109. Valve 109 is controlled by control system 113 to allow the liquid to pass from the inlet end of valve 109 to an outlet end.

As liquid passes through valve 109, it travels through a material application assembly 117. Material application assembly 117 defines a conduit 123 extending from an inlet end (or orifice), which is proximal and attached to an outlet end of valve 109, to an outlet end (or orifice) 119 where the material is discharged into a trench or furrow 162, or proximate a trench or furrow 162, opened by disc opener 114 (as is described in more detail below).

As shown in FIG. 2, outlet end (or orifice) 119 can be a part of a spray tip (or spray nozzle) 125 and application assembly 117 can further include a pressure reduction element 127. Spray tip (or spray nozzle) 125 and examples of pressure reduction element 127 will be described and shown in more detail below. In one example, spray nozzle 125 is a 15-degree spray nozzle, that is, spray nozzle 125 is configured to emit material in a spray fan having an angle of 15 degrees. In another example, spray nozzle 125 has a spray fan angle in the range of 0 degrees (sometimes called straight stream) to 15 degrees. In one example, spray nozzle is a 25-degree spray nozzle, that is, spray nozzle 125 is configured to emit material in a spray fan having an angle of 25 degrees. In another example, spray nozzle 125 has a spray fan angle in the range of 0 degree to 25 degrees. Additionally, as can be seen in FIG. 2, application assembly 117 can include one or more hoses (or tubes) 129. In the example shown in FIG. 2, for instance, a first hose (or tube) 129-1 extends from an outlet of the valve 109 to an inlet of the pressure reduction element 127 and a second hose (or tube) 129-2 extends from an outlet of the pressure reduction element 127 to an inlet of the spray tip (or spray nozzle) 125. This is merely one example. Other examples will be shown and described in more detail below. Additionally, while a particular placement of pressure reduction element 127 is shown in FIG. 2, this is for example only. As will be shown in other examples herein, pressure reduction element 127 can be placed at various other locations within application assembly 117.

Briefly, pressure reduction element 127 defines a select volume configured to reduce the pressure of the material as delivered to the outlet orifice 119, to thereby reduce the exit velocity of the material exiting outlet orifice 119. The amount of material applied by the system is controlled by the opening and closing (e.g., pulse cycle) of the valve. Thus, the opening and closing of the valve 109 can be controlled to control an amount of material applied by the system, as well as the timing of the application. .

FIG. 2 also shows one or more material sensor(s) 200 that may be placed at any of a variety of different locations to detect material applied through application assembly 117. Material sensor(s) 200 can take a wide variety of different forms, some of which are discussed below. The material sensor(s) 200 detect the material so the relationship between where the material is applied and where it should be applied can be identified and actions can be taken based on the relationship.

Some parts of row unit 106 will now be discussed in more detail. First, it will be noted that there are different types of seed meters 124, and the one that is shown is shown for the sake of example only and is described in greater detail below. However, in one example, each row unit 106 need not have its own seed meter. Instead, metering or other singulation or seed dividing techniques can be performed at a central location, for groups of row units 106. The metering systems can include finger pick-up discs and/or vacuum meters (e.g., having rotatable discs, rotatable concave or bowl-shaped devices), among others. The seed delivery system can be a gravity drop system (such as seed tube 120 shown in FIG. 2) in which seeds are dropped through the seed tube 120 and fall (via gravitational force) through the seed tube and out the outlet end 121 into the seed trench 162. Other types of seed delivery systems may be or may include assistive systems, in that they do not simply rely on gravity to move the seed from the metering system into the ground. Instead, such assistive systems actively assist the seeds in moving from the meter to a lower opening, where they exit or are deposited into the ground or trench. These can be systems that physically capture the seed and move it from the meter to the outlet end of the seed delivery system or they can be pneumatic systems that pump air through the seed tube to assist movement of the seed. The air velocity can be controlled to control the speed at which the seed moves through the delivery system. Some examples of assistive systems are described in greater detail below with respect to FIGS. 6 and 7.

A downforce actuator 126 is mounted on a coupling assembly 128 that couples row unit 106 to toolbar 102. Actuator 126 can be a hydraulic actuator, a pneumatic actuator, a spring-based mechanical actuator or a wide variety of other actuators. In the example shown in FIG. 2, a rod 130 is coupled to a parallel linkage 132 and is used to exert an additional downforce (in the direction indicated by arrow 134) on row unit 106. The total downforce (which includes the force indicated by arrow 134 exerted by actuator 126, plus the force due to gravity acting on row unit 106, and indicated by arrow 136) is offset by upwardly directed forces acting on closing wheels 118 (from ground 138 and indicated by arrow 140) and disc opener 114 (again from ground 138 and indicated by arrow 142). The remaining force (the sum of the force vectors indicated by arrows 134 and 136, minus the force indicated by arrows 140 and 142) and the force on any other ground engaging component on the row unit (not shown), is the differential force indicated by arrow 146. The differential force may also be referred to herein as the downforce margin. The force indicated by arrow 146 acts on the gauge wheels 116. This load can be sensed by a gauge wheel load sensor, which may be located anywhere on row unit 106 where it can sense that load. The gauge wheel load sensor can also be placed where it may not sense the load directly, but a characteristic indicative of that load. For example, the gauge wheel load sensor can be disposed near a set of gauge wheel control arms (or gauge wheel arm) 148 that movably mount gauge wheels 116 to shank 152 and control an offset between gauge wheels 116 and the discs in double disc opener 114, to control planting depth.

Arms (or gauge wheel arms) 148 illustratively abut against a mechanical stop (or arm contact member-or wedge) 150. The position of mechanical stop 150 relative to shank 152 can be set by a planting depth actuator assembly 154. Control arms 148 illustratively pivot around pivot point 156 so that, as planting depth actuator assembly 154 actuates to change the position of mechanical stop 150, the relative position of gauge wheels 116, relative to the double disc opener 114, changes, to change the depth at which seeds are planted.

In operation, row unit 106 travels generally in the direction indicated by arrow 160. The double disc opener 114 opens a furrow 162 in the soil 138, and the depth of the furrow 162 is set by planting depth actuator assembly 154, which, itself, controls the offset between the lowest parts of gauge wheels 116 and disc opener 114. Seeds are dropped through seed tube 120, into the furrow 162 and closing wheels 118 close the furrow 162 (e.g., push soil back into the furrow 162).

As the seeds are dropped through seed tube 120, the seeds can be sensed by seed sensor 122. Some examples of seed sensor 122 may include an optical or reflective sensor, which includes a radiation transmitter component and a receiver component. The transmitter component emits electromagnetic radiation and the receiver component then detects the radiation and generates a signal indicative of the presence or absence of a seed adjacent the sensors. In another example, row unit 106 may be provided with a seed firmer that is positioned to travel through the furrow 162, after seeds are placed in furrow 162, to firm the seeds in place. A seed sensor can be placed on the seed firmer and generate a sensor signal indicative of a seed. Some additional examples of seed sensors are described in greater detail below.

The present description proceeds with respect to the seed sensor being located to sense a seed passing it in seed tube 120, but this is for the sake of example only. Material application control system 113 illustratively receives a signal from seed sensor 122, indicating that a seed is passing sensor 122 in seed tube 120. Control system 113 then determines when to actuate valve 109 so that material being applied through material application assembly 117 (and out outlet orifice 119 of material application assembly 117) will be applied at a desired location relative to the seed in trench or furrow 162. One example of how to determine when to actuate valve 109 will now be described.

Control system 113 illustratively is programmed with, or detects a distance, e.g., a longitudinal distance, that the exit orifice 119 is from the exit end 121 of seed tube 120. Control system 113 also illustratively detects, or is provided with (e.g., by another component, such as a GPS unit or a tractor, etc.), the ground speed of row unit 106. As the row units 106 on an implement being towed by a prime mover (e.g., a tractor) may move faster or slower than the tractor during turns, particularly as the width of the implement increases, the control system 113 may sense or be provided the ground speed of each row unit 106 of the implement. By way of example, the control system 113 may sense or be provided information when the implement is turning right indicating that the rightmost row unit 106 is travelling slower, i.e., has a lower ground speed, than the leftmost row unit 106. Further, the control system 113 detects, is provided, or is programmed with, system data indicating the responsiveness of valve 109 under certain conditions (such as under certain temperature conditions, certain humidity conditions, certain elevations, when spraying a certain type of fluid, etc.) and control system 113 also detects, is provided, or is programmed with one or more properties of the material being applied through valve 109 (as this may affect the speed at which valve 109 responds, the time it takes for the material to travel through application assembly 117 to the outlet orifice and be applied to furrow 162, etc.). Further, control system 113 illustratively detects (or is provided with a sensor signal indicative of) the forward speed of row unit 106 in the direction generally indicated by arrow 160.

With this type of information, once control system 113 receives a seed sensor signal indicating that a seed is passing sensor 122 in seed tube 120, control system 113 determines the amount of time it will take for the seed to drop through the outlet end of seed tube 121 and into furrow 162 to reside at its final seed location and position in furrow 162. Control system 113 then determines when outlet orifice will be in a desired location relative to that final seed location and system 113 generates a signal to control actuation of valve 109 to apply the material at the desired location. By way of example, it may be that some material is to be applied directly on the seed. In that case, control system 113 times the actuation of valve 109 so that the applied material will be applied at the seed location. In another example, it may be desirable to apply some material at the seed location and also a predetermined distance on either side of the seed location. In that case, control system 113 generates the signal to control valve 109 so that the material is applied in the desired fashion. In other examples, it may be that the material is to be applied at a location between seeds in furrow 162. By way of example, relatively high nitrogen fertilizer may be most desirably applied between seeds, instead of directly on the seeds. In that case, control system 113 has illustratively been programmed with the desired location of the applied material, relative to seed location, so that it can determine when to actuate valve 109 in order to apply the material between seeds. Further, as discussed above, valve 109 can be actuated, by control system 113, to dispense material at a varying rate. Valve 109 can be actuated to dispense more material on the seed location and less at locations spaced from the seed location, or vice versa, or according to other patterns. Additionally, as previously discussed, the one or more pumps can be controlled, by control system 113, to vary the flow rate of material, such as by increasing the operating pressure by increasing the speed of the one or more pumps 115.

It will be noted that a wide variety of different configurations are contemplated herein. For instance, valve 109 can be placed at various locations, including a location closer to the outlet orifice 119. Similarly, the valve 109 may be placed at other locations. Additionally, as previously discussed, the pressure reduction element 127 can be placed at various locations, including a location closer to or farther from the outlet orifice 119. For instance, in one example, as will be described below, the pressure reduction element 127 may be disposed, at least partially, within the spray nozzle 125.

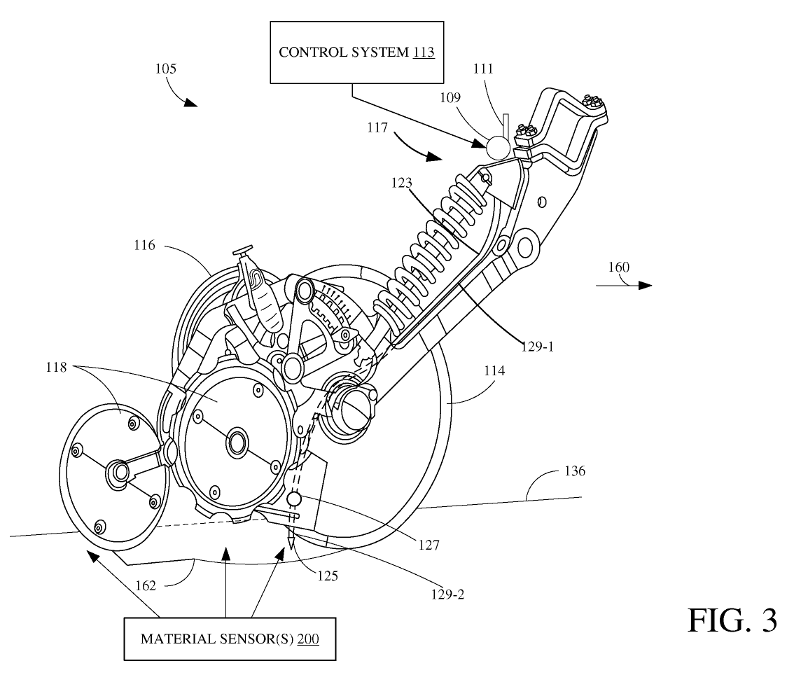

FIG. 3 is a side perspective view of an applicator unit 105. Some items are similar to those shown in FIG. 2 and they are similarly numbered. Briefly, in operation, applicator unit 105 attaches to a side-dress bar that is towed behind a towing vehicle 94, so unit 105 travels between rows (if the rows are already planted). However, instead of planting seeds, it simply applies material at a location between rows of seeds (or, if the seeds are not yet planted, between locations where the rows will be, after planting). When traveling in the direction indicated by arrow 160, disc opener 114 (in this example, it is a single disc opener) opens furrow 162 in the ground 136, at a depth set by gauge wheel 116. When valve 109 is actuated, material is applied in the furrow 162 and closing wheels 118 then close the furrow 162.

As unit 105 moves, control system 113 controls valve 109 to dispense material. Dispensing material can be done relative to seed or plant locations, if they are sensed or are already known or have been estimated. Dispensing material can also be done before the seed or plant locations are known. In this latter scenario, the locations where the material is applied can be stored so that seeds can be planted later, relative to the locations of the material that has been already dispensed.

Material sensor(s) 200 can sense the applied material so a determination can be made as to whether the material was applied to the correct spot. Action signals can be generated as well. Some examples of material sensor(s) 200 are described elsewhere.

While FIG. 3 shows valve 109 disposed at a given location, it will be understood that valve 109 can be disposed at a variety of other locations. Additionally, while FIG. 3 shows pressure reduction element 127 disposed at a given location, it will be understood that pressure reduction element 127 can be disposed at a variety of other locations.

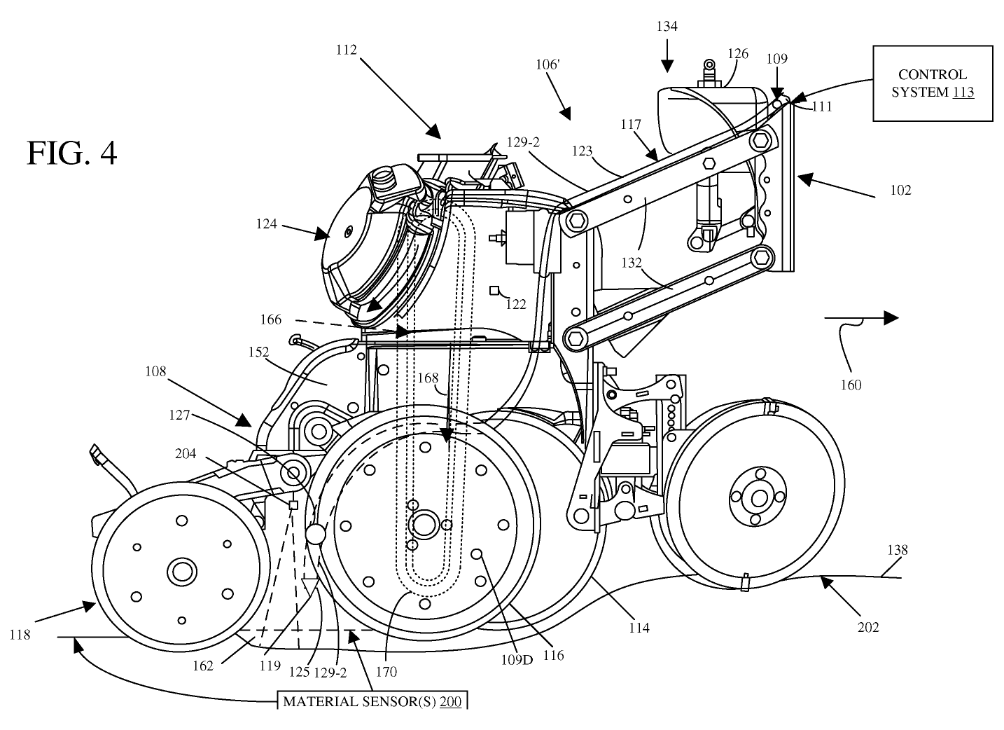

FIG. 4 shows another example of a row unit 106’ which is similar, in some ways, to the row unit 106 shown in FIG. 2, and similar items are similarly numbered. However, instead of the seed delivery system being a seed tube 120, which relies on gravity to move the seed to the furrow 162, the seed delivery system shown in FIG. 4 is an assistive (or active) seed delivery system 166. Assistive seed delivery system 166 also illustratively has a seed sensor 122 disposed therein. There can also be more than one seed sensor 122, seed sensors of different types, seed sensors deployed at different locations, etc. Assistive seed delivery system 166 captures the seeds as they leave seed meter 124 and moves the seeds in the direction indicated by arrow 168 toward furrow 162. System 166 has an outlet end 170 where the seeds exit assistive seed delivery system 166, into furrow 162, where the seeds again reach their final resting location.

In such a system, control system 113 considers the speed at which delivery system 166 moves the seed from seed sensor 122 to the exit end 170. Control system 113 also illustratively considers the speed at which the seed moves from the exit end 170 into furrow 162. For instance, in one example the seed simply drops from exit end 170 into furrow 162 under the force of gravity. In another example, however, the seed can be ejected from assistive seed delivery system 166 at a greater or lesser speed than that which would be reached under the force of gravity. Similarly, it may be that the seed drops straight downward into furrow 162 from the outlet end 170. In another example, however, it may be that the seed is propelled slightly rearwardly from the outlet end 170, to accommodate for the forward motion of the row unit 106’, so that the travel path of the seed is more vertical and so the seed rolls less once it reaches the furrow. Further, the seed can be ejected rearwardly and trapped against the ground by a trailing member (such as a pinch wheel) which functions to stop any rearward movement of the seed, after ejection, and to force the seed into firm engagement with the ground.

FIG. 4 also shows that row unit 106’ can have a row cleaner 202. Row cleaner 202 can take many different forms and is shown as a set of cleaning wheels that remove residue from surface 138 ahead of opener 114. Further, FIG. 4 shows material sensor(s) 200. In one example, sensors 200 can include a sensor 204 (such as a camera, spectroscopy sensor, temperature sensor, electrical property sensor, beam break sensor, or other sensor) that senses the applied material as or after it exits the outlet orifice 119 of the application assembly 117. In another example, sensor(s) 200 can be pressure sensor(s) or flow sensors mounted to sense the pressure or flow of the material being applied. The pressure sensors on flow sensors can sense a pressure or flow of material as it is being applied (e.g., existing valve 109 or nozzle 119), a pressure drop across or flow through valve 109, pressure pulses in material application assembly 117, or another pressure sensor or flow sensor. Other examples of sensors 200 are described in more detail elsewhere herein.

While FIG. 4 shows valve 109 disposed at a given location, it will be understood that valve 109 can be disposed at a variety of other locations. Additionally, while FIG. 4 shows pressure reduction element 127 disposed at a given location, it will be understood that pressure reduction element 127 can be disposed at a variety of other locations.

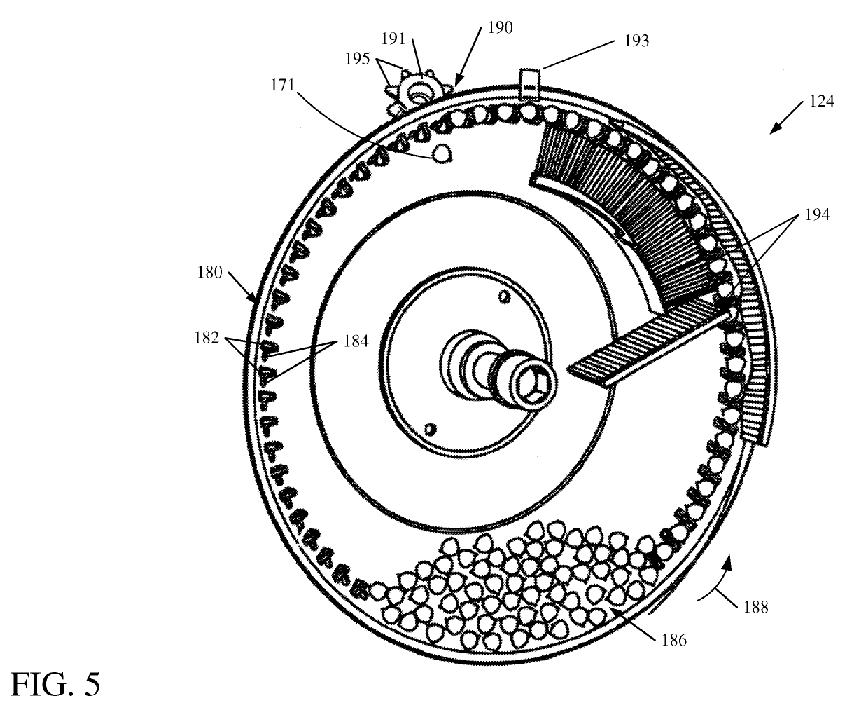

FIG. 5 shows one example of a rotatable mechanism that can be used as part of the seed metering system (or seed meter) 124. The rotatable mechanism includes a rotatable disc, or concave element, 180. Rotatable element 180 has a cover (not shown) and is rotatably mounted relative to the frame of the row unit 106 or 106’. Rotatable element 180 is driven by a motor (not shown) and has a plurality of projections or tabs 182 that are closely proximate corresponding apertures 184. A seed pool 186 is disposed generally in a lower portion of an enclosure formed by rotating mechanism 180 and its corresponding cover. Rotatable element 180 is rotatably driven by its motor (such as an electric motor, a pneumatic motor, a hydraulic motor, etc.) for rotation generally in the direction indicated by arrow 188, about a hub. A pressure differential is introduced into the interior of the metering mechanism so that the pressure differential influences seeds from seed pool 186 to be drawn to apertures 184. For instance, a vacuum can be applied to draw the seeds from seed pool 186 so that they come to rest in apertures 184, where the vacuum holds them in place. Alternatively, a positive pressure can be introduced into the interior of the metering mechanism to create a pressure differential across apertures 184 to perform the same function.

Once a seed comes to rest in (or proximate) an aperture 184, the vacuum or positive pressure differential acts to hold the seed within the aperture 184 such that the seed is carried upwardly generally in the direction indicated by arrow 188, from seed pool 186, to a seed discharge area 190. It may happen that multiple seeds are residing in an individual seed cell. In that case, a set of brushes or other members 194 that are located closely adjacent to the rotating seed cells tend to remove the multiple seeds so that only a single seed is carried by each individual cell. Additionally, a seed sensor 193 can also illustratively be mounted adjacent to rotating element 180. Seed sensor 193 generates a signal indicative of seed presence and this may be used by system 113, as will be discussed in greater detail below.

Once the seeds reach the seed discharge area 190, the vacuum or other pressure differential is illustratively removed, and a positive seed removal wheel or knock-out wheel 191, can act to remove the seed from the seed cell. Wheel 191 illustratively has a set of projections 195 that protrude at least partially into apertures 184 to actively dislodge the seed from those apertures. When the seed is dislodged (such as seed 171), it is illustratively moved by the seed delivery system (e.g., seed tube 120 (some examples shown in FIGS. 2-3) or active seed delivery system 166 (some examples of which are shown in FIGS. 4 and 6-7)) to the furrow 162 in the ground.

FIG. 6 shows an example of a seed metering system and a seed delivery system, in which the rotating element 180 is positioned so that its seed discharge area 190 is above, and closely proximate, assistive seed delivery system 166. In the example shown in FIG. 6, assistive seed delivery system 166 includes a continuous transport mechanism such as a belt 206 with a brush that is formed of distally extending bristles 208 attached to belt 206 that act as a receiver for the seeds. Belt 206 is mounted about pulleys 210 and 212. One of pulleys 210 and 212 is illustratively a drive pulley while the other is illustratively an idler pulley. The drive pulley is illustratively rotatably driven by a conveyance motor, which can be an electric motor, a pneumatic motor, a hydraulic motor, etc. Belt 206 is driven generally in the direction indicated by arrow 168.

Therefore, when seeds are moved by rotating element 180 to the seed discharge area 190, where they are discharged from the seed cells in rotating element 180, the seeds are illustratively positioned within the bristles 208 by the projections 182 that push the seed into the bristles 208. Assistive seed delivery system 166 illustratively includes walls that form an enclosure around the bristles 208, so that, as the bristles 208 move in the direction indicated by arrow 168, the seeds are carried along with the bristles from the seed discharge area 190 of the metering mechanism, to an outlet end or a discharge area 170 either at ground level, or below ground level within the trench or furrow 162 that is generated by the furrow opener 114 on the row unit 106. FIG. 6 shows seeds 167 in furrow 162, seed 161 moving from outlet end 170 to furrow 162, and additional seeds in bristles 208.

Additionally, a seed sensor 122 is also illustratively coupled to seed delivery system 166. As the seeds are moved within bristles 208, sensor 122 can detect the presence or absence of a seed. It should also be noted that while the present description will proceed as having sensors 122, and 193, it is expressly contemplated that, in another example, only one sensor is used. Or additional sensors can also be used. Similarly, the seed sensor 122 shown in FIG. 6 can be disposed at a different location, such as that shown at 122A. Having the seed sensor closer to where the seed is ejected from the system can reduce error in identifying the final seed location. Again, there can be multiple seed sensors, or different kinds of seed sensors, and the seed sensor(s) can be located at many different locations.

FIG. 7 is similar to FIG. 6, except that assistive seed delivery system 166 does not include a belt with distally extending bristles. Instead, it includes a flighted belt (a continuous transport mechanism) in which a set of paddles 214 form individual chambers (or receivers 216), into which the seeds are dropped, from the seed discharge area 190 of the metering mechanism 180. The flighted belt moves the seeds from the seed discharge area 190 to the exit end 170 of the flighted belt, within the trench or furrow 162.

There are a wide variety of other types of seed delivery systems as well, that include a transport mechanism and a receiver that receives a seed. For instance, they include dual belt seed delivery systems in which opposing belts receive, hold, and move seeds to the furrow, a rotatable wheel that has sprockets, which catch seeds from the metering system and move them to the furrow, multiple transport wheels that operate to transport the seed to the furrow, and an auger, among others. The present description will proceed with respect to an endless member (such as a brush belt, a flighted belt) and/or a seed tube, but many other seed delivery systems are contemplated herein as well.

Before continuing with the description of applying material relative to seed location, a brief description of some examples of seed sensors 122, 122A and 193 will first be provided. Sensors 122, 122A and 193 are illustratively coupled to seed metering system 124 and seed delivery system 120, 166. Sensors 122, 122A and 193 sense an operating characteristic of seed metering system 124 and seed delivery systems 120, 166. In one example, sensors 122, 122A and 193 are seed sensors that are each mounted at a sensor location to sense a seed within seed tube 120, seed metering system 124, and assistive seed delivery system 166, respectively, as the seed passes the respective sensor location. In one example, sensors 122, 122A, and 193 are optical or reflective sensors and thus include a transmitter component and a receiver component. The transmitter component emits electromagnetic radiation into seed tube 120, seed metering system 124, and/or delivery system 166. In the case of a reflective sensor, the receiver component then detects the reflected radiation and generates a signal indicative of the presence or absence of a seed adjacent to sensor 122, 122A, and 193 based on the reflected radiation. With other sensors, radiation such as light, is transmitted through the seed tube 120, seed metering system 124, or the delivery system 166. When the light beam is interrupted by a seed, the sensor signal varies, to indicate a seed. Thus, each sensor 122, 122A, and 193 generates a seed sensor signal that pulses or otherwise varies, and the pulses or variations are indicative of the presence of a seed passing the sensor location proximate the sensor.

For example, in regard to sensor 122, bristles 208 pass sensor 122 and are colored to absorb a majority of the radiation emitted from the transmitter. As a result, absent a seed, reflected radiation received by the receiver is relatively low. Alternatively, when a seed passes the sensor location where sensor 122 is mounted, more of the emitted light is reflected off the seed and back to the receiver, indicating the presence of a seed. The differences in the reflected radiation allow for a determination to be made as to whether a seed is, in fact, present. Additionally, in other examples, sensors 122, 122A, and 193 can include a camera and image processing logic that allow visual detection as to whether a seed is present within seed metering system 124, seed tube 120, and/or assistive seed delivery system 166, at the sensor location proximate the sensor. They can include a wide variety of other sensors (such as RADAR or LIDAR sensors) as well.

For instance, where a seed sensor is placed on a seed firmer, it may be mechanical or other type of sensor that senses contact with the seed as the sensor passes over the seed. Also, while the speed of the seed in the delivery system (or as it is ejected) can be identified by using a sensor that detects the speed of the delivery system, in some examples, the speed and/or other characteristics of movement of the seed can be identified using seed sensors. For instance, one or more seed sensors can be located to sense the speed of movement of the seed, its trajectory or path, its instantaneous acceleration, its presence, etc. This can be helpful in scenarios in which the seed delivery system changes speed.

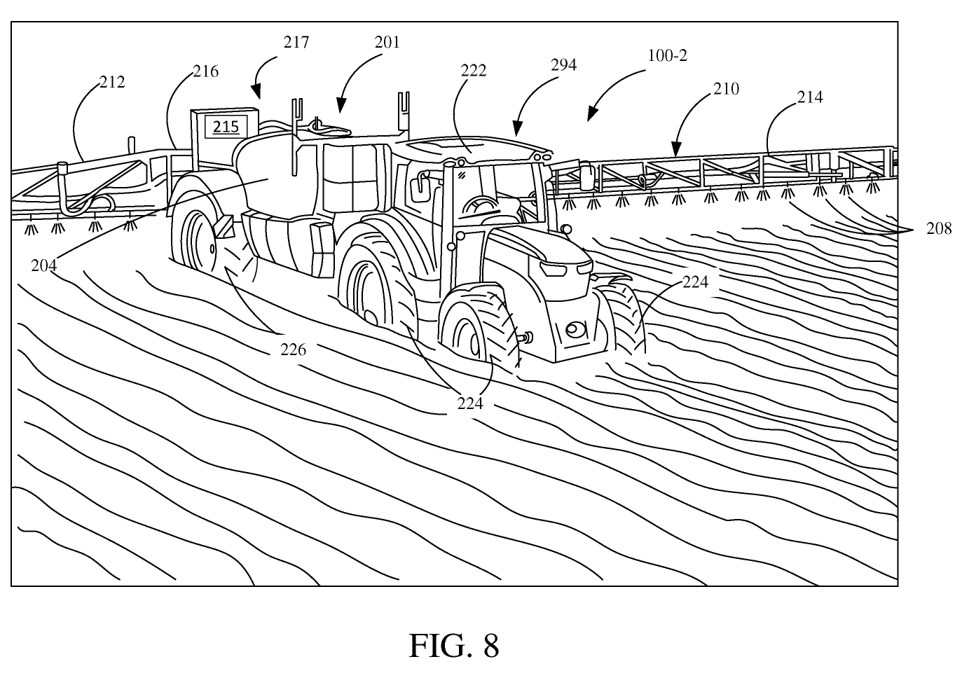

FIG. 8 is a partial pictorial, partial schematic top view of one example mobile agricultural material application machine 100-2 (also referred to herein as material application machine 100-2) that includes a towed agricultural material application implement 201 (also referred to herein as material application implement 201) and a towing vehicle 294, illustratively a tractor. Material application machine 100-2 is an agricultural spraying machine (or agricultural sprayer). Material application machine 100-2 includes a tank 204 containing a liquid that is to be applied to the field. Tank 204 is fluidically coupled to a material application assembly 217 that includes one or more pumps 215, one or more fluid lines (or conduits) (not shown in FIG. 8), and spray nozzles 208. Application assembly 217 can include various other items, including valves and pressure reduction elements, some examples of which will be shown below. The one or more pumps 215 pump the liquid from tank 204 through the conduits through nozzles 208. Spray nozzles 208 are coupled to, and spaced apart along, boom 210. Boom 210 includes arms 212 and 214 which can articulate or pivot relative to a center frame 216. Thus, arms 212 and 214 are movable between a storage or transport position and an extended or deployed position (shown in FIG. 8).

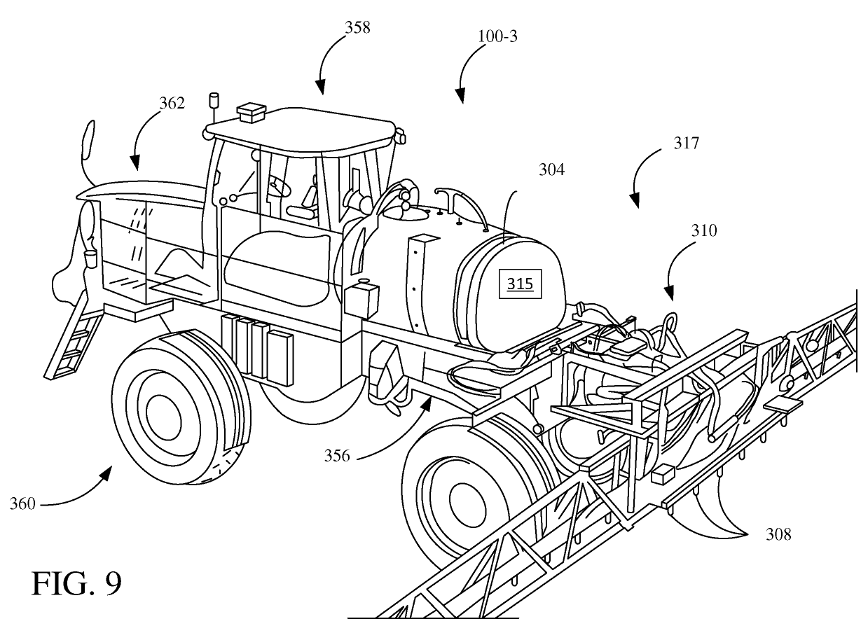

In the example illustrated in FIG. 8, material application machine 100-2 comprises a towed implement 201 that carries the spraying system, and is towed by a towing or support machine 294 (illustratively a tractor) having an operator compartment or cab 222. Towing machine 294 includes a set of traction elements, such as wheels 224. Towed implement 201 includes a set of traction elements, such as wheels 226. The traction elements can also be tracks, or other traction elements as well. It is noted that in other examples, an agricultural sprayer can be self-propelled. That is, rather than being towed by a towing machine, the machine that carries the spraying system also includes propulsion and steering systems. An example of a self-propelled agricultural sprayer is shown in FIG. 9.

FIG. 9 illustrates one example of a material application machine 100-3 (illustratively an agricultural sprayer) that is self-propelled. That is, material application machine 100-3 has an on-board spraying system, that is carried on a machine frame 256 having an operator compartment 258, a steering system 260 (e.g., wheels or other traction elements), and a propulsion system 262 (e.g., internal combustion engine). Material application machine 100-3 includes a tank 404 containing a liquid that is to be applied to the field. Tank 404 is fluidically coupled to a material application assembly 317 that includes one or more pumps 315, one or more fluid lines (or conduits) (not shown in FIG. 8), and spray nozzles 308. Application assembly 317 can include various other items, including valves and pressure reduction elements, some examples of which will be shown below. The one or more pumps 315 pump the liquid from tank 304 through the conduits through nozzles 308. Spray nozzles 308 are coupled to, and spaced apart along, boom 210.

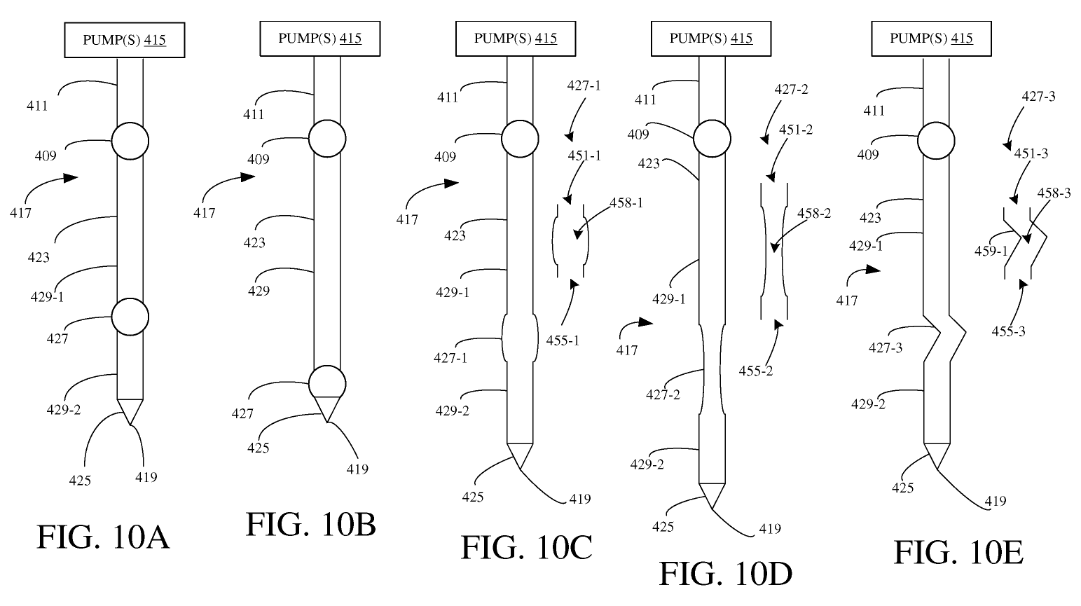

FIGS. 10A-10E are pictorial illustrations showing examples of application assembly 417. Application assembly 417 shows one example of an application assembly 117, 217, or 317. Material to be applied by material application assembly 417 is pumped by one or more pumps 415 from a material source (e.g., one or more tanks, such as 107, 204, or 304) through a supply line 411 to valve 409. Valve 409 is controllably actuated (e.g., opened and closed) to provide material through valve 409to a conduit 423 extending from an outlet of valve 409 to an exit orifice 419. The material flows from the outlet of valve 409 through an inlet of conduit 423 and to, and through, exit orifice 419 to be applied to the agricultural surface (e.g., a field). The conduit includes one or more hoses (or tubes) 129, a pressure reduction element 427, and an exit orifice 419. In the examples shown, the exit orifice 419 is a part of a spray tip (or spray nozzle) 425, though, this need not be the case. The spray tip (or spray nozzle) 425 emits the material in a spray fan (e.g., a flat spray fan or a conical spray fan, etc.). In some examples, the spray fan has an angle of 15 degrees. In some examples, the spray fan has an angle of 0 degrees. In some examples, the spray fan is in the range from 0 degrees to 15 degrees. In one example, the spray fan has an angle of 25 degrees. In some examples, the spray fan has an angle 0 degrees to 25 degrees.

As previously discussed, the pressure of the material can be adjusted (e.g., by adjusting the speed of one or more pumps 415) to achieve a desired flow rate of the material. As the pressure increases, the resultant exit velocity of the material exiting exit orifice 419 increases. The increased exit velocity of the material can have deleterious effects, including overspray, movement of the seeds, contamination or plugging or clogging of other components of material application machine 100. For example, the increased exit velocity of material may cause some material to land on adjacent component of material application machine, such as, in the case of a planting machine, seed delivery system (e.g., 120 or 166) and may impair the operation of the seed delivery system, such as by plugging or clogging the seed delivery system. Additionally, or alternatively, in the case of a planting machine, the increased exit velocity of material may, upon the material impacting the seeds, cause the seeds to move from their desired planting location which may adversely affect resultant yield.

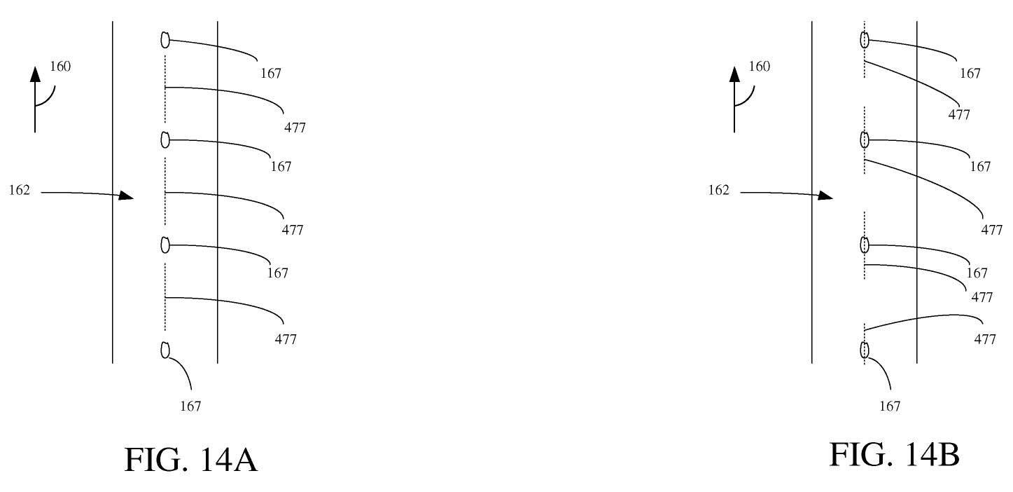

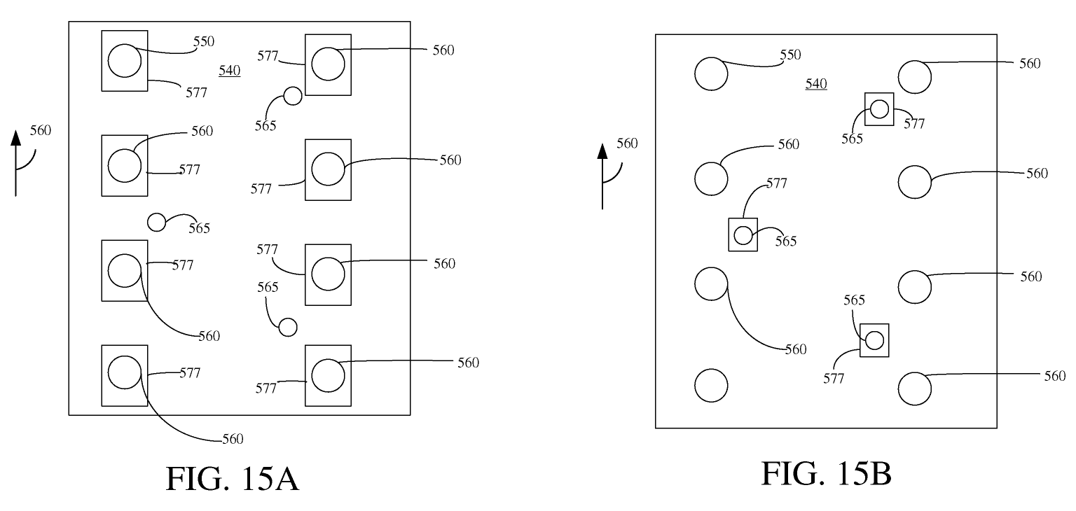

To reduce the increase in exit velocity caused by the increased pressurization, as discussed above, application assembly 417 includes a pressure reduction element 427. Pressure reduction element 427 reduces the pressure of material and thereby reduces the exit velocity of the material. Pressure reduction element 427 defines a select volume configured to reduce the pressure of material as delivered to the outlet orifice 419, to thereby reduce the exit velocity of the material exiting outlet orifice 419. The select volume of pressure reduction element 427 is selected such that pressure can be reduced while still allowing for discrete application of the material with the cycle (e.g., pulse cycle) of the valve 409. The cycle (e.g., pulse cycle) is the time between a first opening of the valve 409 and a second opening of the valve 409, between the first opening and second opening, a closing of the actuator takes place. In pulse width modulation control, the cycle (e.g., pulse cycle) is sometimes referred to as the period. In this way, discrete applications of the material can be achieved and the material will not be applied beyond the desired material application location. In other words, the select volume of pressure reduction element 427 does not result in a continuous stream of material being applied to the agricultural surface, rather, material application will end (or otherwise be interrupted) such that discrete material application locations can be achieved. Some examples of discrete material application are shown in FIGS. 14A-15B. Ideally, the select material volume is the minimum material volume needed to achieve the reduced pressure and thereby the reduced exit velocity. The select material volume of pressure reduction element 127 is different than a material volume of at least one other item of application assembly, such as, different than a material volume of at least one hose (or tube) 429.

As shown in FIG. 10A-10E, the pressure reduction element 427 can be disposed at various locations in application assembly 417 downstream of valve 409 and upstream of exit orifice 419. For example, as shown, the pressure reduction element 427 can be spaced apart from exit orifice 419 and spray tip (or spray nozzle) 425 such that a length of hose (or tube) 429 (e.g., 429-2) extends from an outlet of pressure reduction element 427 and to an inlet of spray tip (or spray nozzle) 425. In another example, as shown, the pressure reduction element 427 can be spaced from outlet orifice 419 such that the outlet of pressure reduction element 427 feeds directly to the inlet of spray tip (or spray nozzle) 425 and no additional hosing or tubing extends between pressure reduction element 427 and spray tip (or spray nozzle) 425. For example, as shown, the pressure reduction element 427 can be, at least partially, disposed withing spray tip (or spray nozzle) 425.

As shown in FIGS. 10C-10E, pressure reduction element 427 can comprise an additional hose (or tube). The pressure reduction element 427 defines a material cavity. The material cavity has a material volume that defines the material volume of the pressure reduction element 427. The material volume of the pressure reduction element 427 is different than a material volume of at least one other item of application assembly 417 (e.g., the material volume of at least one hose (or tube) 429). Additionally, the material cavity of the pressure reduction element 427 varies in at least one dimension (e.g., either length or width, or both) from the material cavity of at least one other item of application assembly 417 (e.g., the material cavity of at least one hose (or tube) of application assembly (e.g., either 429-1 or 429-2, or both)).

In the example shown in FIG. 10C, pressure reduction element 427-1 comprises a hose (or tube) having an inlet orifice 451-1, an outlet orifice 455-1, and a material cavity 458-1 extending between the inlet orifice 451-1 and outlet orifice 455-1. Material cavity 458-1 defines the select material volume of pressure reduction element 427-1. The material cavity 458-1 extends between the inlet orifice 451-1 and outlet orifice 455-1 and between the inner walls of pressure reduction element 427-1. Additionally, as can be seen in FIG. 10C, the material cavity 458-1 of pressure reduction element 427-1 differs in at least one dimension (width) from the material cavity of at least one hose (or tube) 429 (in the example of FIG. 10C, the material cavity 458-1 of pressure reduction element 427-1 differs in at least width from the material cavity of both hose (or tube) 429-1 and hose (or tube) 429-2). As can be seen, the material cavity 458-1 of pressure reduction element 427-1 is wider. Additionally, as shown in FIG. 10C, the material cavity 458-1 of pressure reduction element 427-1 differs in an additional dimension (length) from the material cavity of at least one hose (or tube) 429 (in the example of FIG. 10C, the material cavity 458-1 of pressure reduction element 427-1 differs in length from the material cavity of both hose (or tube) 429-1 and hose (or tube) 429-2). As can be seen, the material cavity 458-1 of pressure reduction element 427-1 is shorter.

In the example shown in FIG. 10D, pressure reduction element 427-2 comprises a hose (or tube) having an inlet orifice 451-2, an outlet orifice 455-2, and a material cavity 458-2 extending between the inlet orifice 451-2 and outlet orifice 455-2. Material cavity 458-2 defines the select material volume of pressure reduction element 427-2. The material cavity 458-2 extends between the inlet orifice 451-2 and outlet orifice 455-2 and between the inner walls of pressure reduction element 427-2. Additionally, as can be seen in FIG. 10D, the material cavity 458-2 of pressure reduction element 427-2 differs in at least one dimension (width) from the material cavity of at least one hose (or tube) 429 (in the example of FIG. 10D, the material cavity 458-2 of pressure reduction element 427-2 differs in at least width from the material cavity of both hose (or tube) 429-1 and hose (or tube) 429-2). As can be seen, the material cavity 458-2 of pressure reduction element 427-2 is narrower. Additionally, as shown in FIG. 10D, the material cavity 458-2 of pressure reduction element 427-2 differs in an additional dimension (length) from the material cavity of at least one hose (or tube) 429 (in the example of FIG. 10C, the material cavity 458-2 of pressure reduction element 427-2 differs in length from the material cavity of both hose (or tube) 429-1 and hose (or tube) 429-2). As can be seen, the material cavity 458-2 of pressure reduction element 427-1 is shorter.

In the example shown in FIG. 10E, pressure reduction element 427-3 comprises a hose (or tube) having an inlet orifice 451-3, an outlet orifice 455-3, a flow diverter 459 (illustratively 459-1) and a material cavity 458-3 extending between the inlet orifice 451-3 and outlet orifice 455-3. Material cavity 458-3 defines the select material volume of pressure reduction element 427-3. The material cavity 458-3 extends between the inlet orifice 451-3 and outlet orifice 455-3 and between the inner walls of pressure reduction element 427-3. Additionally, as can be seen pressure reduction element 427-3 acts as a flow diverter. As can be seen flow diverter 459-1 extends radially away from a central axis of inlet orifice 451-3, for a distance, and then extends back toward the central axis of inlet orifice 451-3.

Flow diversion can be advantageous in that it allows for increased volume of application assembly 417 while reducing the length added by the pressure reduction element 127. It will be understood that the addition of pressure reduction element 427 adds to the length of application assembly 417 which may affect the distance of exit orifice 419 from the agricultural surface as compared to the distance of a standard application assembly. However, the additional length can be accounted for, such as by varying the pathway of conduit 423 as coupled to the material application machine 100, such that the distance of the exit orifice 419 from the agricultural surface will not be changed by the added length of the pressure reduction element 427. Discussion now returns to FIG. 10E.

As can be seen in FIG. 10E, the material cavity 458-3 of pressure reduction element 427-3 differs in at least one dimension (length) from the material cavity of at least one hose (or tube) 429 (in the example of FIG. 10E, the material cavity 458-3 of pressure reduction element 427-3 differs in at least length from the material cavity of both hose (or tube) 429-1 and hose (or tube) 129-2). As can be seen, the material cavity 458-3 of pressure reduction element 427-3 is shorter than the material cavity of hose (or tube) 429-1 and is longer than the material cavity of hose (or tube) 429-2. Additionally, while the example shown in FIG. 10E shows that the width of the material cavity 458-3 of pressure reduction element 427-3 is the same as the width of the material cavity of both hose (or tube) 429-1 and hose (or tube) 429-2, this need not be the case. It will be understood that in other examples, the width of the material cavity 458-3 of pressure reduction element 427-3 can be different than the width of the material cavity of at least one of hose (or tube) 429-1 and hose (or tube) 429-2.

It will be understood that the example pressure reduction elements 427 shown in FIGS. 10C-10E can be spaced from spray tip (or spray nozzle) 425 such that the outlet of the pressure reduction element 427 feeds directly to spray tip (or spray nozzle) 425 and thus, an additional hose (or tube) 429-2 is not needed.

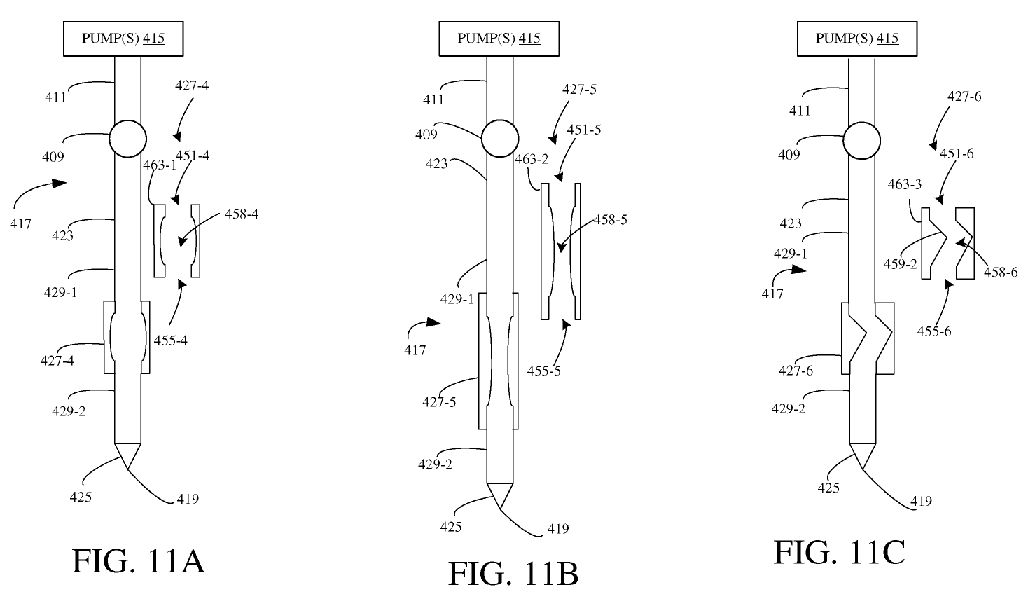

FIGS. 11A-11C are pictorial illustrations showing examples of application assembly 417. FIGS. 11A-11C are similar to FIGS. 10C-10E except that the pressure reduction elements 427 shown in FIGS. 11A-11C are fluid blocks 463 (rather than hoses (or tubes)), that are machined, molded, or otherwise processed to produce the material cavities 458.

It will be understood that a primary difference between the fluid blocks and the hoses (or tubes) is that the hoses (or tubes) are flexible, whereas the fluid blocks are inflexible. However, as the systems discussed herein provide a select volume, it will be understood that while the hoses (or tubes) are flexible, they are relatively inelastic hoses (or tubes) (sometimes called rigid or semi-rigid hoses (or tubes) in that the hoses (or tubes) will, at the operating pressures of the system, resist internal deformation and thus, resist a change (e.g., an increase) in fluid volume. Additionally, the fluid blocks are inflexible (at least, less flexible relative to the hoses (or tubes)) but are also relatively inelastic in that the fluid blocks will, at the operation pressures of the system, resist internal deformation and thus, resist a change (e.g., an increase) in fluid volume.

As can be seen in FIG. 11A, pressure reduction element 427-4 includes a fluid block 463-1 which includes an inlet orifice 451-4, an outlet orifice 455-4, and a material cavity 458-4 extending between the inlet orifice 451-4 and outlet orifice 455-4. Material cavity 458-4 defines the select material volume of pressure reduction element 427-4. The material cavity 458-4 extends between the inlet orifice 451-4 and outlet orifice 455-4 and between the inner walls of pressure reduction element 427-4.

As can be seen in FIG. 11B, pressure reduction element 427-5 includes a fluid block 463-2 which includes an inlet orifice 451-5, an outlet orifice 455-5, and the material cavity 458-5 extending between the inlet orifice 451-5 and outlet orifice 455-5. Material cavity 458-5 defines the select material volume of pressure reduction element 427-5. The material cavity 458-5 extends between the inlet orifice 451-5 and outlet orifice 455-5 and between the inner walls of pressure reduction element 427-5.

As can be seen in FIG. 11C, pressure reduction element 427-6 includes a fluid block 463-3 which includes an inlet orifice 451-6, an outlet orifice 455-6, a flow diverter 459 (illustratively 459-2) and the material cavity 458-6 extending between the inlet orifice 451-6 and outlet orifice 455-6. Material cavity 458-6 defines the select material volume of pressure reduction element 427-6. The material cavity 458-6 extends between the inlet orifice 451-6 and outlet orifice 455-6 and between the inner walls of pressure reduction element 427-6.

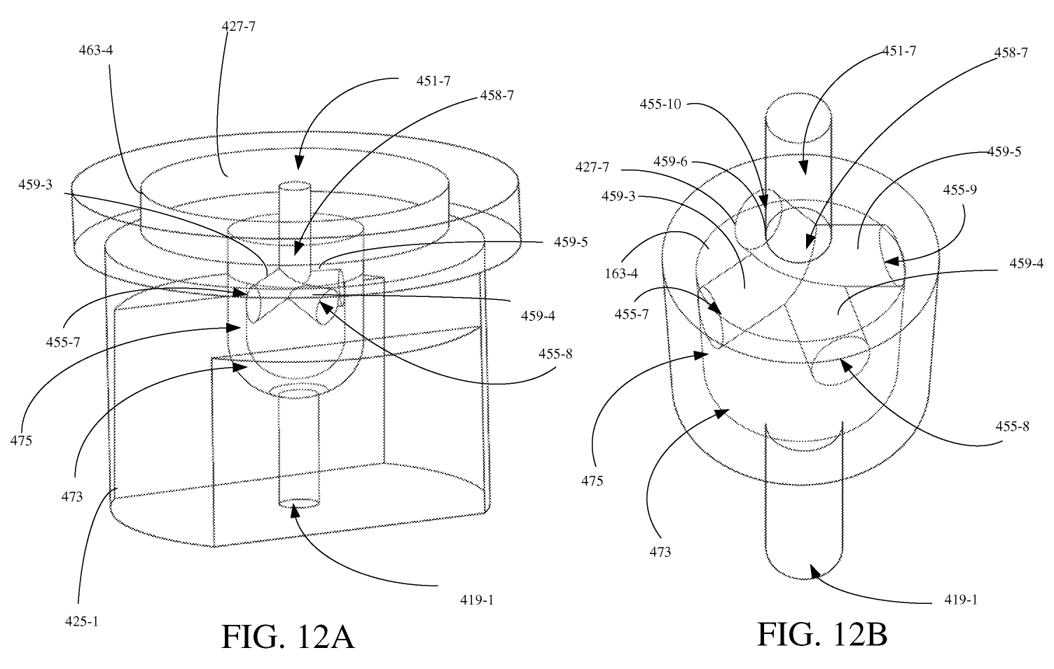

FIGS. 12A-B (collectively referred to herein as FIG. 12) are pictorial illustrations showing one example pressure reduction element 427 (illustratively 427-7) and one example spray tip 425 (illustratively 425-1) which can be included as part of application assembly 417.

As shown in FIG. 12, pressure reduction element 427-7 is disposed at least partially within a spray tip (or spray nozzle) 425 (illustratively 425-1). Pressure reduction element 427-7 includes a fluid block 463-4, an inlet orifice 451-7, a plurality of outlet orifices 455 (illustratively 455-7, 455-8, 455-9 and 455-10), a plurality of flow diverters 459 (illustratively 459-3, 459-4, 459-5, and 459-6), and a material cavity 458-7 extending between the inlet orifice 451-4 and the plurality of outlet orifices 455-7, 455-8, 455-9, and 455-10. Material cavity 458-7 defines the select material volume of pressure reduction element 427-7. The material cavity 458-7 extends between the inlet orifice 451-7 and outlet orifices 455-7, 455-8, 455-9, and 455-10, and between the inner walls of pressure reduction element 427-7. Additionally, as can be seen, pressure reduction element 427-7 acts as a flow diverter. As can be seen, flow diverters 459-3, 459-4, 459-5, and 459-6 extend radially away from a central axis of inlet orifice 451-7. Additionally, as can be seen, each of flow diverters 459-3, 459-4, 459-5, and 459-6 extend radially away from the central axis of inlet orifice 451-7 in a respective, different direction.

Spray tip (or spray nozzle) 425-1 includes a pressure reduction element receiving chamber 473 (illustratively 473-1), an inlet 475 (illustratively 475-1), and an example outlet orifice 419 (illustratively 419-1). As illustrated in FIG. 12, it can be seen that pressure reduction element receiving chamber 473-1 also receives material from pressure reduction element 427-7 and thus, acts as the inlet 475-1 of spray tip (or spray nozzle) 425-1.

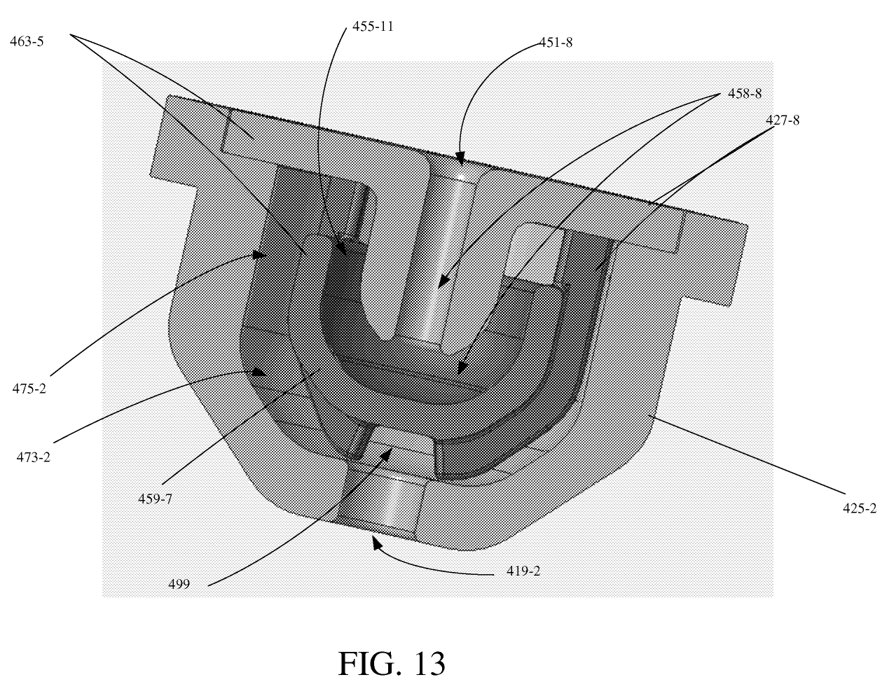

FIG. 13 is sectional view showing one example pressure reduction element 427 (illustratively 427-8) and one example spray tip 425 (illustratively 425-2) which can be included as part of application assembly 417.

As shown in FIG. 13, pressure reduction element 427-8 is disposed at least partially within a spray tip (or spray nozzle) 425 (illustratively 425-2). Pressure reduction element 427-8 includes a fluid block 463-5, an inlet orifice 451-8, an outlet orifice 455-11, a flow diverter 459-7, and a material cavity 458-8 extending between the inlet orifice 451-8 and the outlet orifice 455-11. Material cavity 458-8 defines the select material volume of pressure reduction element 427-8. The material cavity 458-8 extends between the inlet orifice 451-8 and outlet orifice 455-11 and between the inner walls of pressure reduction element 427-8. Additionally, as can be seen, pressure reduction element 427-8 acts as a flow diverter. As can be seen, flow diverter 459-7 extends (in multiple directions) radially away from the central axis of inlet orifice 451-8.

Spray tip (or spray nozzle) 425-2 includes a pressure reduction element receiving chamber 473 (illustratively 473-2), an inlet 475 (illustratively 475-2), and an example outlet orifice 419 (illustratively 119-2). As illustrated in FIG. 13, it can be seen that pressure reduction element receiving chamber 473-2 also receives material from pressure reduction element 427-8 and thus, acts as the inlet 475-2 of spray tip (or spray nozzle) 425-2.

Additionally, it can be seen that pressure reduction element 427-8 includes a channel 499 that provides a pathway for material to move from receiving chamber 473-2 (or inlet 475-2) to outlet 419-2. The channel 499 is provided as a distal tip (relative to the inlet orifice 451-8) of the pressure reduction element 427-8 is in contact with the inner wall of receiving chamber 473-2 (or inlet 475-2). Additionally, as can be seen, channel 499 is aligned with outlet 419-2 and inlet 451-8, and extends across pressure reduction element 427-8, transverse to the longitudinal axis of pressure reduction element 427-8.

In one example, the inlet orifice 151 of a pressure reduction element 127 may have the same cross-sectional area as the cross-sectional area of the outlet orifice 119. In one example, the inlet orifice 151 of a pressure reduction element 127 may have a greater cross-sectional area than the cross-sectional area of the outlet orifice 119. In one example, the inlet orifice of a pressure reduction element 127 may have a lesser cross-sectional area than the cross-sectional area of the outlet orifice 119. It will be understood that the term cross-sectional area is used to include examples where the orifices are not circular, for instance, an orifice may be a cat-eye orifice, or another type of shape. In some examples, where the orifices are both circular, it will be understood that the inlet orifice 151 may have a larger diameter than a diameter of the outlet orifice 119, that the inlet orifice 151 may have a smaller diameter than a diameter of the outlet orifice 119, or that the inlet orifice 151 may have a same diameter as the diameter of the outlet orifice 119. Also, it will be understood that the orifice sizes (cross-sectional areas or diameters) described above apply in the sense of the orifice sizes as intended or as designed. Those skilled in the art will appreciate that the actual orifice sizes may differ from the intended (or as designed) orifice sizes due to manufacturing tolerances or wear from use, or both. For instance, where the inlet orifice 151 and outlet orifice 119 are intended (or designed) to be of a same size (cross-sectional area or diameter), the inlet orifice 151 and outlet orifice 119 may have a different size due to manufacturing tolerances or due to wear from use, or both.

FIGS. 14A-14B are top views of a furrow (or trench) showing examples of discrete material application performed by material application machine 100 in the form of an agricultural planting machine, such as material application machine 100-1. As illustrated in FIG. 14A, in some examples, material is discretely applied by material application machine 100 by delivering material 477 to discrete locations between seeds 177 in a furrow 162 opened by the material application machine 100 as the material application machine 100 travels in the travel direction 160. As illustrated in FIG. 14B, in some examples, material is discretely applied by material application machine 100 by delivering material 477 to discrete locations on and a certain distance before and after the seeds 477 in the furrow 162 opened by the material application machine 100 as the material application machine 100 travels in the travel direction 160. As can be seen, there is a break between material application locations, that is, the material is not applied in a continuous stream to the agricultural surface. While FIGS. 114A-14B show examples of discrete application in the context of planting (or seeding), it will be understood that the systems herein can be used in other material application operations and with other material application machines, for example, in spraying operations and in spraying machines. In a spraying operation, and with use in a spraying machine, the systems herein can provide discrete application of material to target locations, such as only the crop plants (or only the crop plants and a select area around the crop plants) or such as only to weeds (or only to weeds and a select area around the crop plants) and thus, the systems herein can be used in spraying and in spraying machines to provide material discretely. Examples of discrete material application with an agricultural sprayer will be shown in FIGS. 15A-15B.

FIGS. 15A-15B are top views of a field showing examples of discrete material application performed by material application machine 100 in the form of an agricultural sprayer, such as a material application machine 100-2 or 100-3.

As illustrated in FIG. 15A, in some examples, material is discretely applied by material application machine 100 by delivering material 577 to discrete locations on and around crop plants 560 on field 540 as the material application machine 100 travels in a travel direction 560. As illustrated in FIG. 15B, in some examples, material is discretely applied by material application machine 100 by delivering material 577 to discrete locations on and around weed plants 565 as the material application machine 100 travels in a travel direction 560. As can be seen, there is a break between material application locations, that is, the material is not applied in a continuous stream to the agricultural surface.

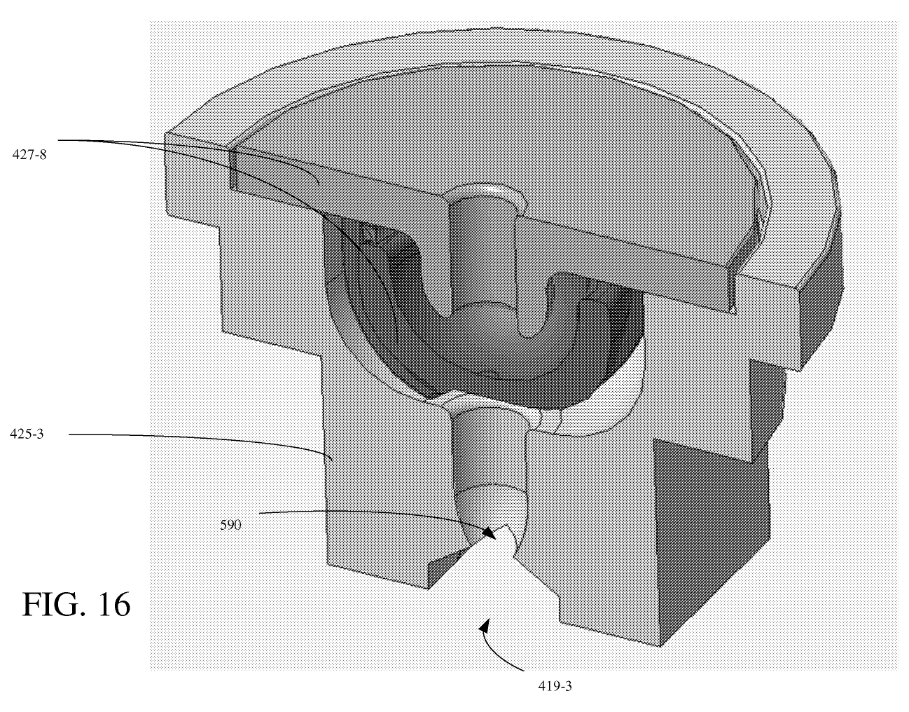

FIG. 16 is a sectional view showing an example of pressure reduction element 427-8 disposed in a different example nozzle 425 (illustratively 425-3). Nozzle 425-3 differs from nozzle 425-2 shown in FIG. 13 in that nozzle 425-3 includes an exit orifice 419-3, different than 419-2. Exit orifice 419-3 includes a cat-eye feature 590 that produces a flat spray fan with a narrow spray fan angle, such as up to 15 degrees or up to 25 degrees.

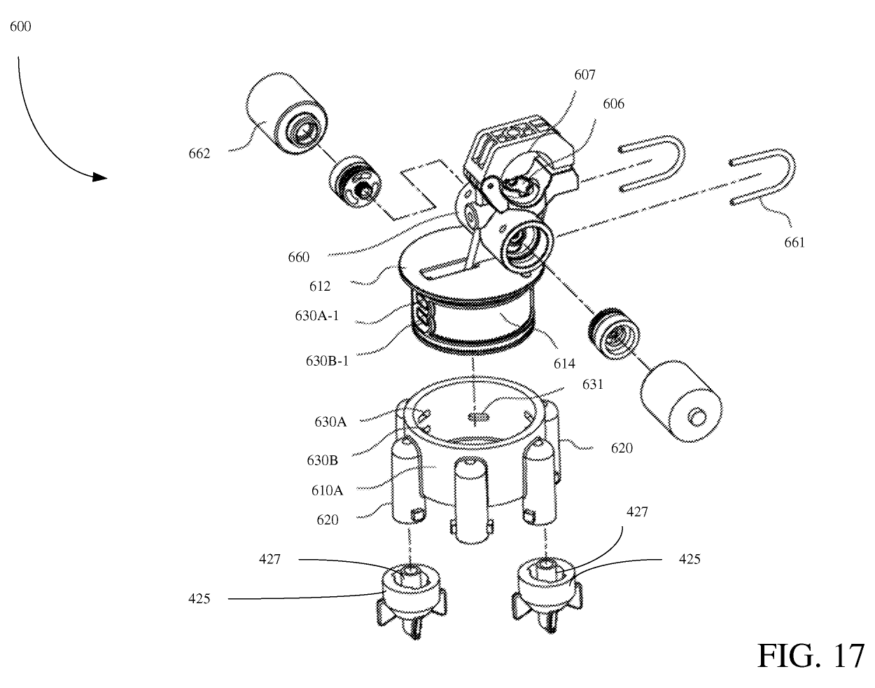

FIG. 17 is an exploded view showing one example multi-nozzle assembly 600. An agricultural sprayer, such as 100-2 or 100-3, or both, can include, in place of the individual nozzles 208 and 308 shown in FIGS. 8 and 9, respectively, multiple multi-nozzle assemblies 600 spaced apart along the boom or otherwise across the sprayer. As shown in FIG. 17, a multi-nozzle assembly 600 can include multiple nozzles 425 (e.g., 425-2 or 425-3) and pressure reduction elements 427 (e.g., 427-8).

Multi-nozzle assembly 600 includes a tube 660 connected to a turret 614 that are located above and mate to receptacle 610A when turret 614 is inserted into receptacle 610A. Tube 660 is positioned like a handle to turret 614 to manually (or electronically) turn turret 614 inside receptacle 610A. Turret 614 has a top surface 612 and a cylindrical wall having apertures such as 630A-1 and 630B-1 and single apertures (not shown). The turret mate 614 slides into and is rotatable in the turret receptacle 610A; the two objects are coupled to each other through retaining elements, such as nubs or clips (e.g. like medical bottle caps). The turret 614 is rotatable within the turret receptacle 610A to controllably align (or mate) apertures of the turret 614 with apertures of the receptacle 610A to provide fluid pathways to select nozzles 425. Multi-nozzle assembly 600 further includes an inlet 606 that receives fluid (such as from a conduit of a boom) and a mount ring 607 for mounting to a boom. Additionally, multi-nozzle assembly 600 includes an actuator 662, such as a valve (e.g., solenoid, PWM valve, etc.). Pins 661 couple the actuator 662 to the nozzle tube 660.

Multi-nozzle assembly 600 also includes a plurality of nozzle (or spray tip) mounting structures 620. Each mounting structures 620 is configured to receive fluid (received through inlet 606 and released by actuator 662) and provide a fluid pathway to the respective nozzle 425 mounted to the mounting structure 620. The nozzles 425, which include the inserted pressure reduction element 627, are configured to removably couple to a respective mounting structure, such as by a snap-on or twist on connection. While only two nozzles are shown in FIG. 17, it will be understood that more (e.g., six) nozzles 425 can be coupled to receptacle 610A via a respective mounting structure 620. The rotational position of turret mate 614 acts to activate and deactivate one or more nozzles 425, for instance, a different pair of nozzles 425 can be active with each different rotational position of turret mate 614.

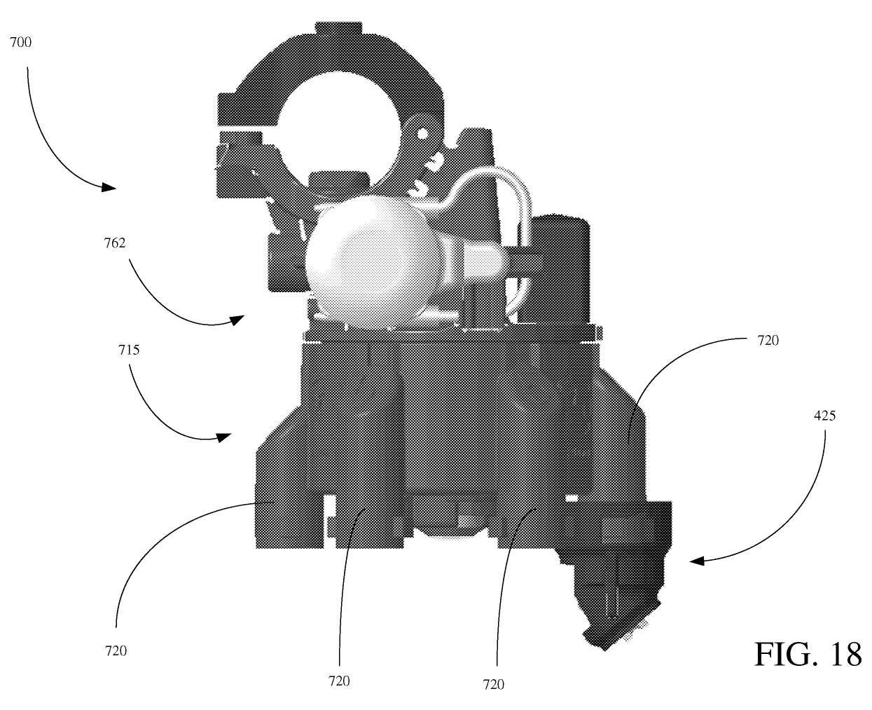

FIG. 18 is a pictorial illustration showing one example multi-nozzle assembly 700. An agricultural sprayer, such as 100-2 or 100-3, or both, can include, in place of the individual nozzles 208 and 308 shown in FIGS. 8 and 9, respectively, multiple multi-nozzle assemblies 700 spaced apart along the boom or otherwise across the sprayer. As shown in FIG. 18, a multi-nozzle assembly 700 can include a rotatable turret assembly 715, one or more nozzles (or spray tips) 425 (e.g., 425-2 or 425-3), and an actuator 762. The turret assembly 715 is rotatable for selection and activation of one or more nozzles 425. The turret assembly 715 can be rotated manually or by an actuator (e.g., motor, etc.). The turret assembly 715 includes a plurality of nozzle (or spray tip) mounting structures 720. A nozzle (or spray tip) 425 can be mounted to each mounting structure 720. Each mounting structure 720 provides a fluid pathway for fluid (provided by actuator 762) to reach the correspondingly mounted nozzle 425. Actuator 762 can be, in one example, a valve (e.g., solenoid, PWM valve, etc.). It will be understood that, while not shown in FIG. 18, the nozzles 425 can also include pressure reduction elements 427 (e.g., 427-8).

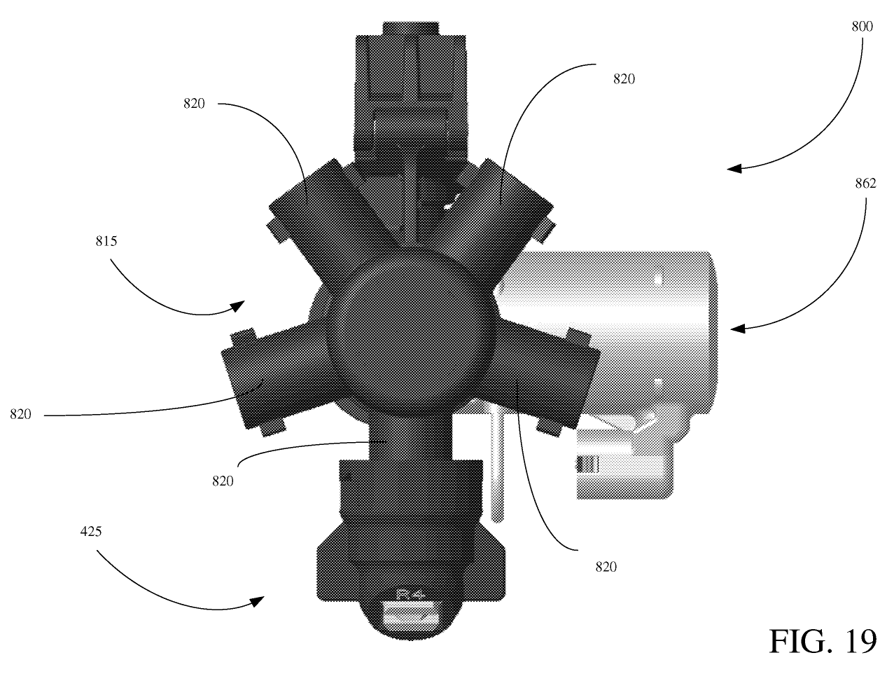

FIG. 19 is a pictorial illustration showing one example multi-nozzle assembly 800. An agricultural sprayer, such as 100-2 or 100-3, or both, can include, in place of the individual nozzles 208 and 308 shown in FIGS. 8 and 9, respectively, multiple multi-nozzle assemblies 800 spaced apart along the boom or otherwise across the sprayer. As shown in FIG. 19, a multi-nozzle assembly 800 can include a rotatable turret assembly 815, one or more nozzles (or spray tips) 425 (e.g., 425-2 or 425-3), and an actuator 862. The turret assembly 815 is rotatable for selection and activation of one or more nozzles 425. The turret assembly 815 can be rotated manually or by an actuator (e.g., motor, etc.). The turret assembly 815 includes a plurality of nozzle (or spray tip) mounting structures 820. A nozzle (or spray tip) 425 can be mounted to each mounting structure 820. Each mounting structure 820 provides a fluid pathway for fluid (provided by actuator 862) to reach the correspondingly mounted nozzle 425. Actuator 862 can be, in one example, a valve (e.g., solenoid, PWM valve, etc.). It will be understood that, while not shown in FIG. 19, the nozzles 425 can also include pressure reduction elements 427 (e.g., 427-8).

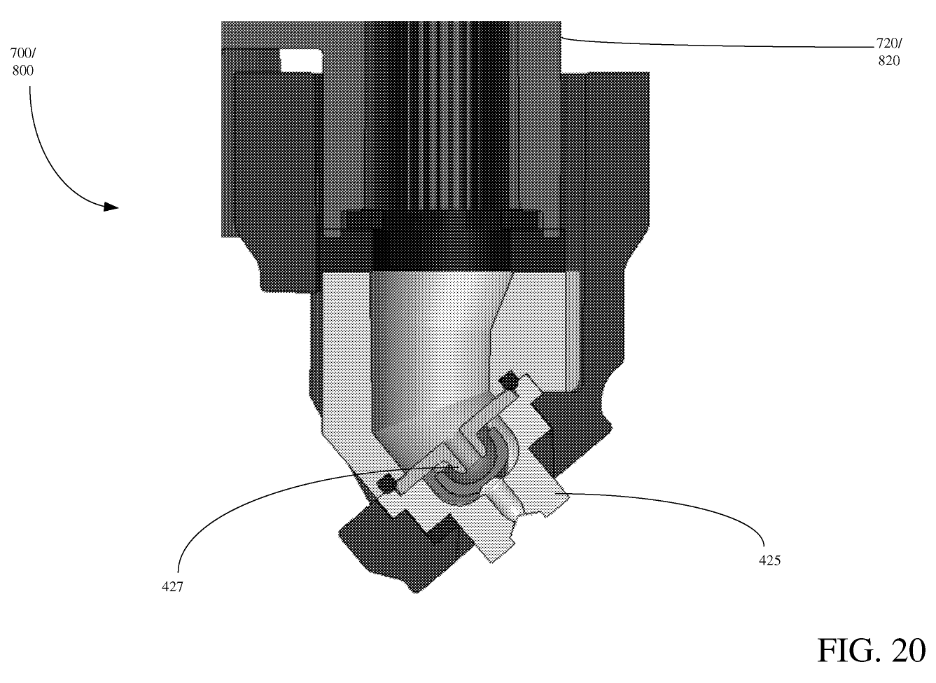

FIG. 20 is a sectional view showing an example of multi-nozzle assembly 700 or multi-nozzle assembly 800. In the illustrated example, a single mounting structure (either 720 or 820) is shown, to which a nozzle 425 and pressure reduction element is mounted 427. As shown in inf FIG. 20, the nozzle 425 and pressure reduction element 427 can be mounted to the mounting structure such that the nozzle 425 is at an angle relative to the agricultural surface (i.e., such that the nozzle 425 is not pointed straight down towards the agricultural surface).

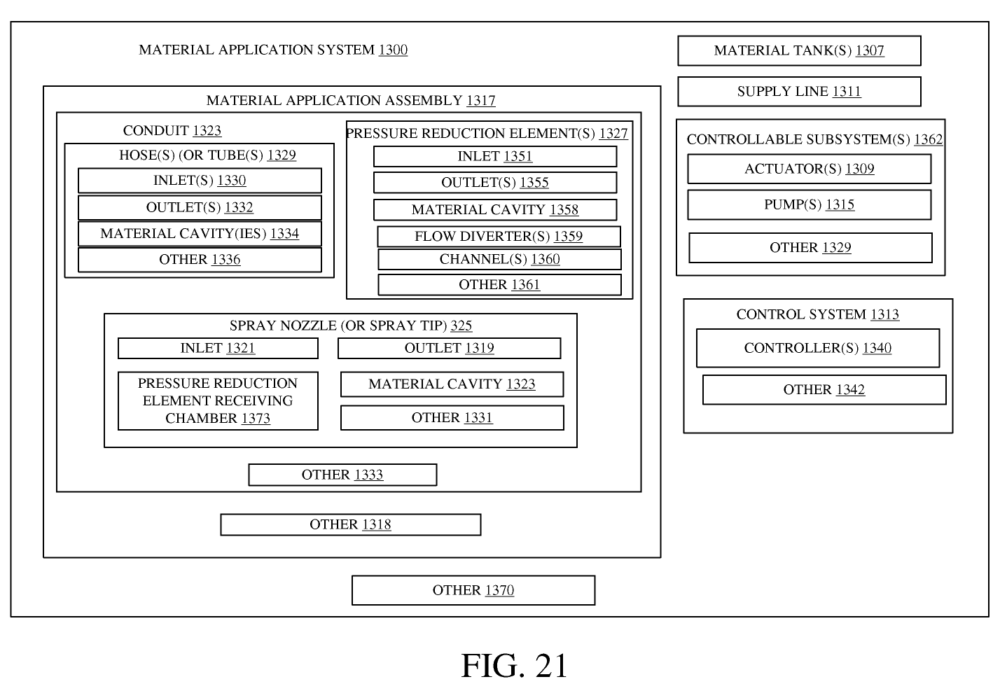

FIG. 21 is a block diagram of one example material application system 300. As shown in FIG. 21, material application system 1300 can be a part of a material application machine, such as material application machine 100 (e.g., 100-1, 100-2, 100-3). Additionally, it will be understood that a material application machine, such as material application machine 100, can include a plurality of material application systems 1300, or a plurality of material application assemblies 1317, such as a material application system 1300, or a material application assembly 1317, for each row unit (e.g., 106, 106’) or for each nozzle or each multi-nozzle assembly (e.g., 425 or 600/700/800, respectively). Material application system 1300 includes material application assembly 1317, material tanks 1307, supply line 1311, control system 1113, controllable subsystems 1362, and can include various other items 1370.

Material application assembly 1317 includes a conduit 1323 and can include other items 1318 as well. Conduit 1323 can include one or more hoses (or tubes) 1329, a spray nozzle (or spray tip) 1325, a pressure reduction element 1327, and can include various other items 1333 as well. In some examples, material application assembly 1317 can be or can be similar to a material application assembly 117, or a material application assembly 217, or a material application assembly 317, or a material application assembly 417, discussed herein.

Each hose (or tube) 1329 can include an inlet 1330, an outlet 1332, a material cavity 1334, and can include other items 1336 as well. The inlet 1330 can be coupled to an outlet of another item, such as an outlet of an actuator 1309 (e.g., a valve) or an outlet of a pressure reduction element 1327. The outlet 1332 can be coupled to the inlet of another item, such as an inlet of a pressure reduction element 1327 or an inlet of a spray nozzle (or spray tip) 1325. In other examples, the outlet 1332 of a hose (or tube) 1329 may be the final outlet orifice (e.g., 119) of a material application assembly 1317, such as in an example where the material application assembly 1317 does not include a spray nozzle (or spray tip) 1325. The material cavity 1334 defines a material volume of the hose (or tube) 1329 and extends between the inlet 1330 and outlet 1332 and between the interior walls of the hose (or tube) 1329. In one example, hoses (or tubes) 1329 can be similar to any one of hoses (or tubes) 429.

Spray nozzle (or spray tip) 1325 can include an inlet 1321, an outlet 1319, a pressure reduction element receiving chamber 1373, and a material cavity 1323, and can include other items 1331 as well. The inlet 1321 can be coupled to the outlet of another item, such as an outlet of a hose (or tube) 1329 or an outlet of a pressure reduction element 1327. The outlet 1319 can be the final outlet (e.g., 419) of material application assembly 1317 and can be configured to emit material in a spray fan having a spray fan angle. In one example, the spray fan angle can be 0 degrees. In another example, the spray fan angle can be 15 degrees. In another example, the spray fan angle can be in the range of 0 degrees to 15 degrees. In another example, the spray fan angle can be 25 degrees. In another example, the spray fan angle can be in the range of 0 degrees to 25 degrees. In some examples, a spray nozzle (or spray tip) 1325 can include a pressure reduction element receiving chamber 1373 configured to receive at least a portion of pressure reduction element 1327. In one example, pressure reduction element receiving chamber 1373 can also be the inlet 1321. In one example, pressure reduction element receiving chamber 1373 can be similar to pressure reduction element receiving chamber 473. The material cavity 1323 defines a material volume of the spray nozzle (or spray tip) 1325 and extends between the inlet 1321 and the outlet 1319 and between the interior walls of the spray nozzle (or spray tip) 1325. In one example, spray nozzles (or spray tips) 1325 can be similar to any one of spray nozzles (or spray tips) 425.

Pressure reduction element 1327 can include an inlet 1351, one or more outlets 1355, a material cavity 1358, one or more flow diverters 1359, and can include other items 1361 as well. In some examples, pressure reduction element 1327 can also include one or more channels 1360, such as channel 499. The inlet 1351 can be coupled to an outlet of another item, such as an outlet of a hose (or tube) 1329. The one or more outlets 1355 can be coupled to the inlet of another item, such as an inlet of a hose (or tube) 1329 or an inlet of a spray nozzle (or spray tip) 1325. In some examples, pressure reduction element1 327 can include one or more flow diverters 1359. In one example, each flow diverter 359 can extend, at least for some distance, radially away from a central axis of inlet 1351, in one or more directions, and may terminate at a respective outlet 1355. In some examples, pressure reduction element 1327 can include a plurality of flow diverters that each extend radially away from a central axis of inlet 1351 in a respective direction, such as in the example shown in FIG. 12. The material cavity 1358 defines a material volume of the pressure reduction element 1327 and extends between the inlet 1351 and the outlet 355 and between the inner walls of the pressure reduction element 1327. In one example, a pressure reduction element 1327 can be a hose (or tube). In one example, a pressure reduction element 327 can be a fluid block. In one example, pressure reduction elements 327 can be similar to any one of pressure reduction elements 427.

Pressure reduction element 1327 has a select volume, defined by the material cavity 358, that is configured to reduce the pressure of material delivered to the final outlet orifice of application assembly and thus, reduce an exit velocity of the material exiting the final outlet orifice.. The select volume of pressure reduction element 327 is different than a volume of at least one other item of material application assembly 1317, such as a volume of at least one of hoses (or tubes) 1329. Additionally, the material cavity 1358 of pressure reduction element 1327 is different in at least one dimension (e.g., either length or width, or both), than a material cavity of at least one other item of material application assembly 1317, such as a material cavity 1334 of at least one of hoses (or tubes) 1329. The pressure reduction element 1327 is downstream of actuator 1309 and upstream of the final outlet orifice of material application assembly 1317.

The one or more material tanks 1307 hold material to be applied by material application system 1300. In one example, material tanks 1307 can be similar to material tanks 107, or material tanks 204, or material tanks 304. Supply line 1311 provides a conduit from pumps 1315 to actuators (or valves) 1309.

Controllable subsystems can include one or more actuators (or valves) 1309, one or more pumps 1315, and can include other items 1329 as well. Pumps 1315 are controllable to pressurize and pump material from material tanks 1307 to actuators (or valves) 1309. Actuators (or valves) 1309 are controllably actuatable (e.g., controllably openable and closeable) to allow the pressurized material to application assembly 1317. In one example, actuators (or valves) 1309 are similar to actuators (or valves) 109 or actuators (or valves) 662/762/862. In one example, pumps 1315 are similar to pumps 115, or pumps 215, or pumps 315.

Control system 113 can include one or more controllers 1340 and can include other items 342. One more controllers 1340 can generate control signals to control actuators (or valves) 1309 or pumps 1315, or both, to control flow rate and application of material. As previously discussed, one or more controllers 1340 can generate control signals to adjust the operating pressure of the material (and thus the flow rate of material) by controlling pumps 1315, such as by controlling the speed of pumps 1315. Additionally, as previously discussed, controllers 1340 can generate control signals to control actuators (or valves) 1309 to actuate to allow a desired amount of material to flow to material application assembly 1317. For example, a control signal to control an actuator (or valve) 1309 can be a pulse width modulated control signal. The flow through the corresponding actuator (or valve) 1309 can be based on the duty cycle of the control signal (which controls the amount of time the valve is open and closed). The flow through the actuator (or valve) 1309 can be based on multiple duty cycles of multiple valves or based on other criteria. The control signal can be a different type of control signal as well, instead of a pulse width modulated control signal.

It should also be noted that the different examples described herein can be combined in different ways. That is, parts of one or more examples can be combined with parts of one or more other examples. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A mobile agricultural material application machine comprising:
a material tank configured to hold a material;
a pump configured to pump material from the material tank;
a controllable valve having a valve inlet and a valve outlet, the controllable valve configured to receive material pumped from the material tank and allow material to pass through the valve outlet during a cycle; and
a conduit comprising:
an inlet configured to receive material from the controllable valve;
an outlet defining an exit from the conduit through which material can pass to be applied to the agricultural surface; and
a pressure reduction element downstream of the inlet and upstream of the outlet and having a selected volume configured to reduce a pressure and exit velocity of the material.

2. The mobile agricultural material application machine of claim 1, wherein the conduit comprises a hose, the hose comprising the inlet and a house outlet, the pressure reduction element having a pressure reduction element inlet configured to receive material from the hose.

3. The mobile agricultural material application machine of claim 2, wherein the pressure reduction element comprises a flow diverter that extends, at least for a distance, radially away from a central axis of the inlet of the pressure reduction element.

4. The mobile agricultural material application machine of claim 3, wherein the flow diverter extends radially away from the central axis of the inlet of the pressure reduction element for a distance in each of a plurality of directions.

5. The mobile agricultural material application machine of claim 3, wherein the pressure reduction element comprises a plurality of flow diverters, wherein the flow diverters is one of the plurality of flow diverters, wherein each flow diverter, of the plurality of flow diverters extends radially away from the central axis of the inlet of the pressure reduction element for a distance in a respective direction.

6. The mobile agricultural material application machine of claim 3 and further comprising a spray tip, the spray tip including the outlet and configured to emit the material in a spray fan, wherein the pressure reduction element is disposed, at least partially, in a receiving chamber of the spray tip.

7. The mobile agricultural material application machine of claim 2, wherein the selected volume of the pressure reduction element is different than a volume of the hose.

8. The mobile agricultural material application machine of claim 7, wherein the pressure reduction element comprises an additional hose.

9. The mobile agricultural material application machine of claim 7, wherein the pressure reduction element comprises a fluid block.

10. The mobile agricultural material application machine of claim 2, wherein the pressure reduction element includes a material cavity and wherein the hose comprises a material cavity, the material cavity of the pressure reduction element being different in at least one dimension than the material cavity of the hose.

11. An agricultural material application system comprising:
a controllable valve having a valve inlet and a valve outlet, the controllable valve configured to receive material pumped from a material source and allow material to pass through the valve outlet during a cycle; and
a conduit comprising:
a hose configured to receive material from the controllable valve;
an outlet defining an exit from the conduit through which material can pass to be applied to an agricultural surface; and
a pressure reduction element downstream of the hose and upstream of the outlet and having a selected volume configured to reduce a pressure of the material and exit velocity of the material.

12. The agricultural material application system of claim 11, wherein the pressure reduction element comprises a flow diverter that extends, at least for a distance, radially away from a central axis of an inlet of the pressure reduction element.

13. The agricultural material application system of claim 11, wherein the selected volume of the pressure reduction element is different than a volume of the hose.

14. The agricultural material application system of claim 11, wherein the pressure reduction element includes a material cavity and wherein the hose comprises a material cavity, the material cavity of the pressure reduction element being different in at least one dimension than the material cavity of the hose.

15. The agricultural material application system of claim 11 and further comprising a spray tip, the spray tip including the outlet and configured to emit the material in a spray fan.

16. The agricultural material application system of claim 15, wherein the pressure reduction element is disposed, at least partially, in a receiving chamber of the spray tip, the pressure reduction element configured to divert flow of material in a plurality of directions extending radially away from a central axis of an inlet of the pressure reduction element.

17. An agricultural material application assembly comprising:
a material tank configured to hold a material;
a controllable valve configured to control a flow of the material;
a conduit fluidically coupled to the controllable valve and configured to receive material, the conduit comprising:
an outlet defining an exit from the conduit through which material can pass to be applied to an agricultural surface; and
a pressure reduction element downstream of the controllable valve and upstream of the outlet and having a selected volume configured to reduce a pressure and exit velocity of the material.

18. The agricultural material application assembly of claim 17, wherein the conduit further comprises a hose, the hose upstream of the pressure reduction element and downstream of the controllable valve.

19. The agricultural material application assembly of claim 18, wherein the hose comprises a first hose, the conduit further comprising a second hose downstream of the pressure reduction element, wherein the selected volume of the pressure reduction element is different than both a volume of the first hose and a volume of the second hose.

20. The agricultural material application assembly of claim 17, the conduit further comprising a spray tip, the spray tip including the outlet and configured to emit the material in a spray fan having a spray fan angle in the range of zero degrees to twenty-five degrees, and
wherein the pressure reduction element is configured to divert flow of the material in one or more directions radially away from a central axis of an inlet of the pressure reduction element.
